(19) United States
(12) Patent Application Publication
(10) Pub. No.: US 2025/0339763 A1
(43) Pub. Date: Nov. 6, 2025

(54) SCRATCH-OFF DOCUMENT MICROSCRATCHING COUNTERMEASURES

(71) Applicant: Brightstar Global Solutions Corporation, Providence, RI (US)

(72) Inventors: Kenneth Irwin, JR., Dawsonville, GA (US); Brian Ingram, Murphy, NC (US); Fran Cash, Wilmington, NC (US)

(21) Appl. No.: 19/269,599

(22) Filed: Jul. 15, 2025

Related U.S. Application Data
(63) Continuation of application No. 17/814,975, filed on Jul. 26, 2022.
Application No. 17/814,975 is a continuation of application No. 17/498,236, filed on Oct. 11, 2021.

(51) Int. Cl. A63F 3/06

(52) U.S. Cl. CPC A63F 3/0665; A63F 3/0655; A63F 2250/58

(57) ABSTRACT

A full-color protected document, printing method, and system secured by removable Scratch-Off Coatings where the protection against microscratch type attacks is provided by ensuring strategic placement of similarly colored and/or patterned variable indicia. By printing the variable indicia with similarly standards, usability and integrity of the printed indicia are achieved relative to the consumer's perspective while at the same time providing countermeasures to illicit microscratching attacks.

### PRIORITY

This application is a continuation of, claims priority to and the benefit of U.S. patent application Ser. No. 17/814,975, filed on Jul. 26, 2022, which application is a continuation of, claims priority to and the benefit of U.S. patent application Ser. No. 17/498,236, filed on Oct. 11, 2021, the entire contents of each of which is incorporated by reference herein.

### BACKGROUND

The present disclosure relates generally to documents, such as instant lottery tickets, having variable indicia under a Scratch-Off Coating (SOC), and systems, methods, and devices that provide protection against microscratch type attacks on SOC protected documents.

Lottery scratch-off or instant games have become a time-honored method of raising revenue for state and federal governments the world over. The concept of hiding indicia (e.g., play symbols) under a Scratch-Off Coating (SOC) has also been applied to numerous other products such as commercial contests, telephone card account numbers, gift cards, etc. Literally, billions of scratch-off products are printed every year where the Scratch-Off-Coatings (SOCs) are used to ensure that the product has not been previously used, played, or modified. SOC lottery tickets are used as the primary example of such products or documents herein.

The variable indicia of scratch off lottery tickets may printed using a specialized high-speed ink jet image sandwiched between lower security ink film layers and upper security barriers that protect the indicia from illicit identification with unsold lottery tickets. The purpose being to ensure that the printed variable indicia cannot be read or decoded without first removing the associated SOC in a manner that it would be obvious to a consumer of the lottery ticket that the variable indicia has been revealed—thereby ensuring that the lottery game is secure against picking out winners or extracting confidential information from unsold lottery tickets.

The common practice of securing the variable indicia by sandwiching it between lower and upper security ink film security barriers has been shown to be susceptible to what is often called microscratch or “pin-prick” attacks, where a nefarious person attempts to identify winning indicia under the SOC via a series of small holes through the SOC such that the compromised lottery ticket still appears to be intact and unplayed to the untrained and/or unmagnified eye, and therefore could be sold to an unsuspecting consumer. The microscratching of small holes through the SOC such that the holes would not be readily identifiable by an unsuspecting legitimate lottery ticket consumer purchasing an unplayed lottery ticket but are nevertheless large enough to enable a nefarious person to identify winning indicia under microscopic inspection remains an issue for the lottery ticket industry.

One known countermeasure against microscratching is to “float” each variable indicum (i.e., each variable indicum may be positioned in a different portion over a limited area on the X/Y two-dimensional lottery ticket substrate) to increase the difficulty for any nefarious person attempting to pick out variable indicia by microscratching. However, primarily due to the limited lottery ticket surface available to “float” each variable indicum without colliding into adjacent indicia, this “float” countermeasure has been shown to be less effective in numerous circumstances.

### BRIEF SUMMARY

Various embodiments of the present disclosure relate to a lottery ticket including a substrate and winning indica printed on the substate, the winning indicia including a predominate first color, the predominate first color being representable as a first point on a color gamut, the first point on the color gamut being a center point of a predefined area of the color gamut. The lottery ticket further includes non-winning variable indicia printed on the substrate, the non-winning variable indicia including a predominate second color, the predominate second color being representable as a second point on the color gamut, the second point located within the predefined area on the color gamut. The lottery ticket further includes a first scratch off coating covering the non-winning variable indicia.

Various embodiments of the present disclosure relate to a lottery ticket including a substrate and winning indica printed on the substate, the winning indicia including a first pattern including a first quantity of first pattern fundamental geometric parameters. The lottery ticket further includes non-winning variable indicia printed on the substrate, the non-winning variable indicia including a second pattern including a second quantity of second fundamental geometric parameters, wherein the second quantity of fundamental geometric parameters are within plus-or-minus (±) 3.5% of the first quantity of fundamental geometric parameters. The lottery ticket further includes a first scratch off coating covering the variable indicia.

Various embodiments of the present disclosure relate to a lottery ticket including a substrate and winning indica printed on the substate, the winning indicia including a first color, the first color including at least fifty percent of a predominate first color element. The lottery ticket further includes non-winning variable indicia printed on the substrate, the non-winning variable indicia including a second color, the second color including at least fifty percent of the predominate first color element. The lottery ticket further includes a first scratch off coating covering the non-winning variable indicia.

Additional features are described herein, and will be apparent from the following Detailed Description and the figures.

### BRIEF DESCRIPTION OF THE SEVERAL VIEWS OF THE DRAWINGS

The patent or patent application file contains multiple drawings executed in color. Copies of this patent or patent application publication with color drawings will be provided by the Office upon request and payment of the necessary fee.

FIG. 1A are two exemplary front elevation views of a known lottery ticket illustrating the same ticket in before and after the SOC is removed.

FIG. 1B is a first detailed magnified view of a portion of interest of the lottery ticket of FIG. 1A showing microscratch lines under normal (white light) illumination.

FIG. 1C is a second detailed magnified view of a similar portion of interest of the lottery ticket of FIG. 1A showing microscratch pin-prick holes under normal (white light) illumination.

FIG. 1D is a third detailed magnified view of the same portion of interest of the lottery ticket of FIG. 1C under 715 nanometer (nm) Infrared (IR) illumination highlighting the variable indicia images revealed by the microscratch pin-prick holes.

FIG. 1E is the same portion of interest of the lottery ticket of FIG. 1D under IR illumination with the addition of a straight pin laid on top of the SOC to illustrate the degree of magnification of the figure.

FIG. 2A is a front elevation view of an example “key match” lottery ticket configuration of one example embodiment of the present disclosure illustrated before the SOC has been removed and with the SOC in pristine condition.

FIG. 2B is a second front elevation view of the example “key match” lottery ticket configuration of FIG. 2A illustrated in fully scratched and played condition with the SOC removed.

FIG. 2C is a magnified view of the instruction portion of the “key match” lottery ticket of FIGS. 2A and 2B.

FIG. 2D is a third front elevation view of the exemplary “key match” lottery ticket with detailed magnified views of portions of interest including microscratching through portions of the SOC highlighting non-winning variable indicia that are not in compliance with the present disclosure.

FIG. 2E is a fourth front elevation view of the exemplary “key match” lottery ticket with detailed magnified views of portions of interest including microscratching through portions of the SOC highlighting winning variable indicia that are not in compliance with this present disclosure.

FIG. 2F is a fifth front elevation view of the exemplary “key match” lottery ticket configuration of the present disclosure of FIGS. 2A and 2B with detailed magnified views of portions of interest including microscratching through portions of a SOC highlighting winning and non-winning variable indicia that are in compliance with one embodiment of the present disclosure.

FIG. 3A is a planar view of a representative example of a process color gamut highlighting the predominate colors of the winning indicia of FIG. 2F.

FIG. 3B illustrates representative examples of the winning indicia similar color spaces on the process color gamut of FIG. 3A with respect to a first embodiment of the present disclosure.

FIG. 3C illustrates representative examples of the winning indicia similar color spaces on the process color gamut of FIG. 3A with respect to a second embodiment of the present disclosure.

FIG. 3D illustrates representative examples of the winning indicia similar color spaces on the process color gamut of FIG. 3A with respect to a third embodiment of the present disclosure.

FIG. 3E provides various examples of alternative color gamut structures that are compatible with the embodiments of FIGS. 3B, 3C, and 3D in accordance with the present disclosure.

FIG. 4A is a front elevation view of the exemplary winning indicia from FIGS. 2A thru 2F and 3A thru 3D paired with correlated “similarly” colored non-winning indicia.

FIG. 4B is a front elevation view of some of the exemplary winning indicia and correlated “similarly” colored non-winning indicia from FIG. 4A identifying the various regions of differing patterns present in the winning indicia.

FIG. 4C is a front elevation view of the remainder of the exemplary winning indicia and correlated “similarly” colored non-winning indicia from FIG. 4A identifying the various regions of differing patterns present in the winning indicia.

FIG. 5A is an alternative front elevation view of a “key match” lottery ticket configuration of one embodiment of the present disclosure illustrated before the SOC has been removed and with the SOC in pristine condition.

FIG. 5B is a second front elevation view of the alternative “key match” lottery ticket configuration of FIG. 5A illustrated in fully scratched and played condition.

FIG. 5C is a front elevation view of the exemplary “key match” lottery ticket configuration of FIGS. 5A and 5B with detailed magnified views of portions of interest including microscratching through portions of a SOC highlighting winning and non-winning variable indicia that are in compliance with one embodiment of the present disclosure.

FIG. 6 is a schematic front isometric view of an exemplary embodiment of an inline process color digital imager capable of printing the exemplary instant lottery ticket variable indicia of FIGS. 2A thru 2F and 5A thru 5C.

### DETAILED DESCRIPTION

Certain terminology is used herein for convenience only and is not to be taken as a limitation on the present disclosure. The words “image” or “print” are used equivalently and mean that whatever indicium or indicia is or are created directly or indirectly on any substrate or surface may be done by any known or new imaging or printing method or equipment. Likewise, “imaging” or “printing” describing a method and “imaged” or “printed” describing the resulting indicium or indicia are used equivalently and correspondingly to “image” or “print.”

The words “a” and “an”, as used in the claims and in the corresponding portions of the specification, mean “at least one.” The terms “scratch-off game piece” or other “scratch-off document,” hereinafter may sometimes be referred to generally as an “instant ticket,” a “lottery ticket,” or simply as a “ticket.” The terms “full-color” and “process color” are also used interchangeably throughout the present disclosure as terms of convenience for producing a variety of colors by discrete combinations of applications of primary inks or dyes “CMY” (i.e., Cyan, Magenta, and Yellow), or the more common four color “CMYK” (i.e., Cyan, Magenta, Yellow, and black), or in some cases six colors (e.g., Hexachrome printing process uses CMYK inks plus Orange and Green inks), or alternatively eight colors—e.g., CMYK plus lighter shades of cyan (LC), magenta (LM), yellow (LY), and black (YK). Also, the term “ink” is used for convenience herein to include either or both of “pigmented inks” and well as “colored dyes.”

The term “composite color” refers to two or more individual colors used to comprise an overall “process color” with the term “component color” referring to a single individual color that is used with at least one other component color to create a combined “composite” or “process” color. The term “spot color” as used herein refers to a color that is intended to be printed and displayed by itself and not intended to be utilized as a “composite color” or “process color”.

The terms “multi” or “multiple” or similar terms means at least two, and may also mean three, four, or more, for example, unless otherwise indicated in the context of the use of the terms. The term “variable” indicium or indicia refers to imaged indicia which indicates information relating a property, such as, without limit, a value of the document, for example, a lottery ticket, coupon, commercial game piece or the like, where the variable indicium or indicia (e.g., win or lose symbols) is or are typically hidden by a Scratch-Off Coating (SOC) until the information or value is authorized to be seen, such as by a purchaser of the document who scratches off the SOC, revealing the variable indicium or indicia. Examples of variable indicium as a printed embodiment include letters, numbers, icons, or figures. The terms “lottery scratch-off ticket”, “commercial contest scratch ticket”, “telephone card account number card”, “scratch-off gift cards”, or simply “scratch-off card” for convenience are all referred to as an “instant ticket” or more simply “ticket” throughout the present disclosure.

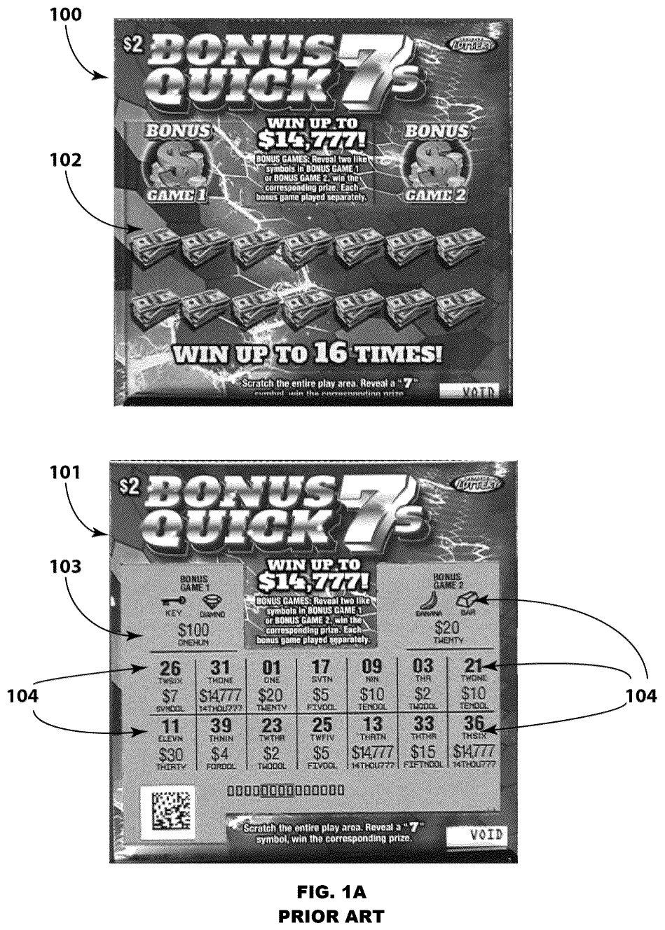

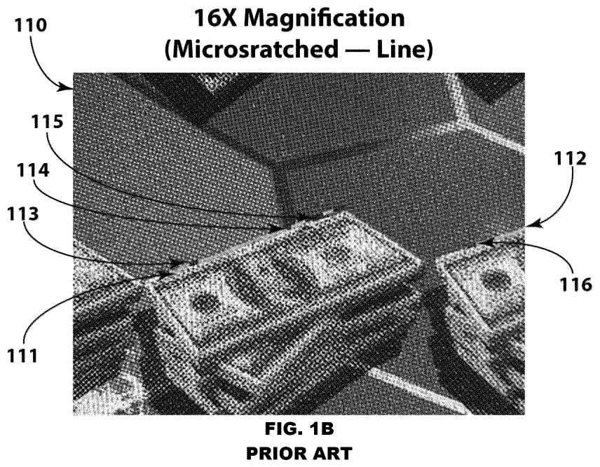

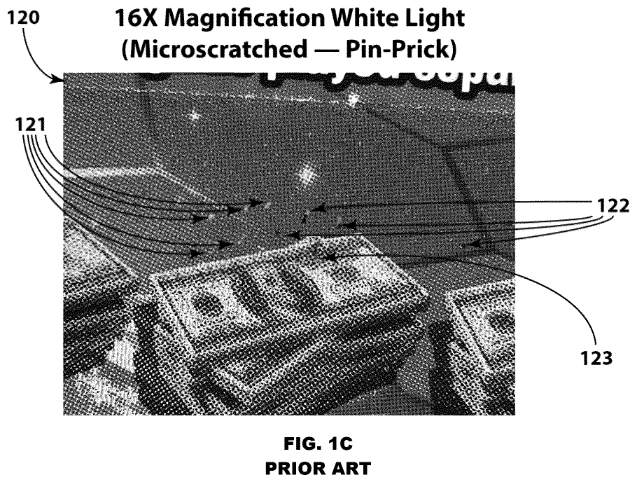

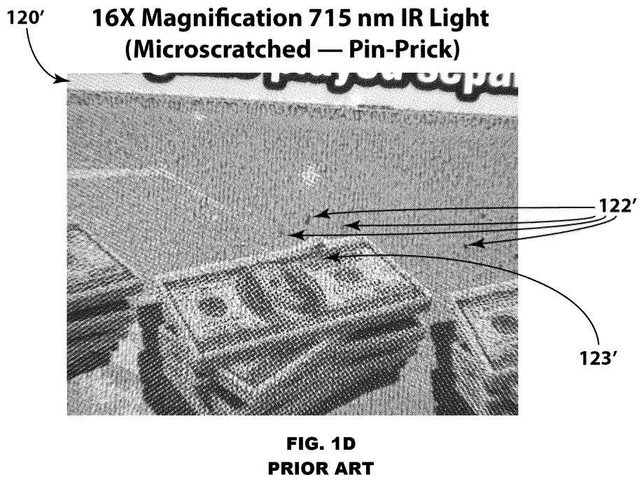

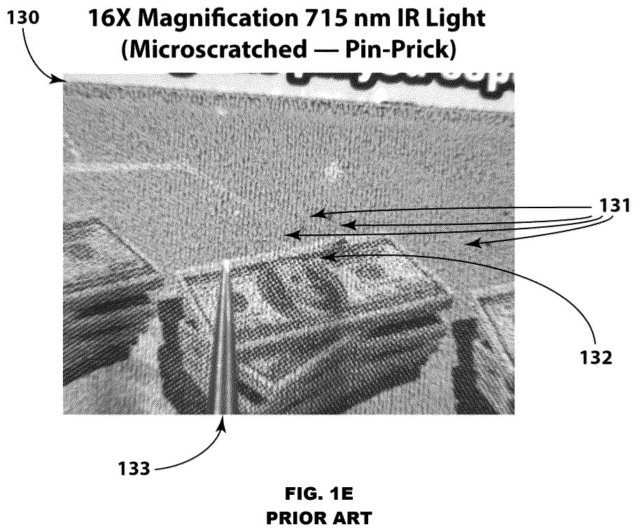

Before describing the present disclosure, it is useful to first provide detailed examples of microscratching to illustrate the scale of the known breaching of the SOC as well as to ensure that a common lexicon is established prior to a more detailed explanation of the present disclosure. This exemplary description of microscratching is provided in the discussions of FIGS. 1A thru 1E.

FIG. 1A provides two front elevation illustrations of a known example lottery ticket in a pristine condition 100 and the known lottery ticket in a fully scratched condition 101. As shown in FIG. 1A, the pristine condition 100 ticket's SOC 102 conceals all the variable indicia and includes a decorative overprint design. The fully scratched-off condition 101 of the same ticket reveals a lower security surface 103 (predominately magenta in FIG. 1A) that is a composite of the lower security ink film layers on which the variable indicia are printed as well as the variable indicia 104 itself. The goal of any microscratching attack is to leave the SOC 102 to appear intact and pristine to a casual observer while at the same time inserting sufficient surreptitious microscratch lines and/or pin-prick holes to identify winning variable indicia 104 under the SOC 102.

FIG. 1B provides an exemplary illustration of one type of microscratch attack 110 where a knife (e.g., X-Acto® blade) is utilized to surreptitiously create slices 111 and 112 through the SOC on a portion of the overprint design (e.g., the edges of the printed one-hundred-dollar bill images) where the knife creates slices 111 and 112 that are not apparent to a casual consumer purchasing the lottery ticket. However, under magnification (sixteen times in FIG. 1B), the nefarious microscratch actor can see portions of the variable indicia 113 thru 116 through the slices 111 and 112 in sufficient quantity to possibly pick-out lottery tickets with winning variable indicia from a collection of unsold lottery tickets, thereby only or primarily selling known losing lottery tickets to the unsuspecting public.

FIG. 1C illustrates a second type of microscratch attack 120, with sixteen times magnification, where very small pin-prick holes 121, 122, and 123 were punched through the SOC instead of surreptitious slices in a different type of attempt to pick-out lottery tickets with winning variable indicia from a collection of unsold lottery tickets. As shown in FIG. 1C, the multiple microscratch pin-prick holes either reveal portions of the lower security surface 103 of FIG. 1A or portions of the monochromatic variable indicia 104 of FIG. 1A. FIG. 1D shows approximately the same image 120′ under Infrared (IR) illumination (i.e., 715 nm wavelength, typically abbreviated by the Greek letter lambda “2”) that highlights the pin-prick holes 122′ and 123′ where portions of variable indicia were revealed.

Thus, in the case of the exemplary lottery ticket of FIGS. 1A, 1B, and 1C, the nefarious microscratch attacker is essentially attempting to discern binary information (i.e., does the microscratch reveal portions of the lower security surface “logic 0₂” or portions of the variable indicia “logic 1₂”) through the microscratch slices or holes. As will be discussed later in this disclosure, the security risks associated with microscratching can be compounded with the addition of full color variable indicia.

As previously discussed, FIGS. 1B, 1C, and 1D show a portion of the exemplary lottery ticket 100 of FIG. 1A under sixteen times magnification to enable the reader to view the microscratch breaches in the SOC with an unaided eye. To provide a visual comparison of the very small sizes typical of microscratch attacks (i.e., for the attack to more likely be successful, it must leave the SOC in a pristine appearance to the unaided eye), FIG. 1E illustrates approximately the same image area 130 as 120′ of FIG. 1D with the addition of a portion of a common straight pin 133 laid on top of the SOC. From a casual observation of FIG. 1E, it can be readily appreciated how small the typical microscratch breaches in the SOC are relative to the overall lottery ticket's size and why a successful microscratch attack would most likely go undetected by an unsuspecting consumer.

Reference will now be made in detail to examples of the present disclosure, one or more embodiments of which are illustrated in the drawings. Each example is provided by way of explanation of the present disclosure, and not meant as a limitation of the present disclosure. For example, features illustrated or described as part of one embodiment, may be used with another embodiment to yield still a further embodiment. The present disclosure encompasses these and other modifications and variations as come within the scope and spirit of the present disclosure. As mentioned above, lottery tickets are used herein as an example of the documents of the present disclosure for brevity and are not meant to limit the present disclosure.

One aspect of the present disclosure relates to a lottery ticket for an instant lottery ticket “key match” game in which instructions are shown in the display area (i.e., visible on an unscratched or unplayed lottery ticket) full-color winning variable indica (symbols) for a given lottery ticket where the consumer would win a prize if a revealed full-color indicium (symbol) previously hidden under the SOC matches the known winning indicum printed in the always visible display area. The present disclosure provides a method, system, and document for printing non-winning full-color variable indicia that would significantly resemble a known winning indicium when viewed from the perspective of a microscratch attack, yet when viewed from the perspective of a fully played (i.e., completely scratched) lottery ticket, the winning indicium would be readily distinguishable from the non-winning indicia. In various example embodiments of this present disclosure, the predominate color(s) of the full-color known winning indicum and the predominate color(s) of the full-color non-winning indicia are assigned specific metrics for comparison purposes, thereby enabling analytical parameters to determine if the known winning indicum colors and the non-winning indicia colors would appear to be similar or identical under a microscratch attack.

In various embodiments, a portion of the winning or non-winning indicia at least partially can also comprise patterns. The present disclosure also provides a method, system, and document for printing non-winning variable indicia patterns that would significantly resemble the known winning indicium when viewed from the perspective of a microscratch attack, yet when viewed from the perspective of a fully played lottery ticket would not appreciably resemble the known winning indicium patterns. With another embodiment of the present disclosure, similar to the previous color embodiment, the patterns of the known winning indicum and the patterns of the non-winning indicum are given specific metrics for comparison purposes, again enabling analytical parameters to determine if the known winning indicum patterns and the non-winning indicum patterns would appear to be similar or identical under a microscratch attack.

While the above described aspects of the present disclosure concerns microscratch countermeasures for “key match” types of instant lottery ticket games, another aspect of the present disclosure concerns similar microscratch countermeasures arranged for instant lottery ticket games where the winning indicia are not known to the consumer prior to removing the SOC. For example, the key match indicia is hidden under the SOC and not visible on unplayed lottery tickets (e.g., “Winning Symbols” and “Your Symbols” fields). For these types of instant lottery ticket games with this aspect of the present disclosure, the same countermeasure embodiments (i.e., winning and non-winning indicia predominate color similarities and winning and non-winning indicia pattern similarities) are utilized, however as will be shown, different security metrics are employed to maintain the same level of security. In various embodiments, the present disclosure provides a lottery ticket including a substrate, winning indica printed on the substate, non-winning variable indicia printed on the substrate, a first SOC covering the non-winning variable indicia. In further embodiments, the lottery ticket includes a second SOC covering the winning indicia. The winning indicia includes a predominate first color being representable as a first point on a color gamut. The first point on the color gamut constitutes a center point of a predefined area of the color gamut. The non-winning variable indicia includes a predominate second color also being representable as a second point on the color gamut, wherein the second point is located within the predefined area of the first point on the color gamut. The non-winning winning variable indicia thus significantly resembles the winning indicia when viewed from the perspective of a microscratch attack. If a person uses a microscratch attack, the person would think that this ticket is a winning lottery ticket based on this similarity of color, but in fact, it is a losing lottery ticket. After this occurs one or more times, the person would thus be discouraged from such microscratch attacks. It is noted that if the person would try to make the holes in the SOC larger to be able to better detect the color distinctions, the hole would be more visible to a potential customer of the lottery ticket.

As further described below, in various such embodiments, the center point of the predefined area is a mean average of a predefined range of the predominate first color. As further described below, in various such embodiments, the predominate first and second colors each comprise one of a Cyan component color, a Magenta component color, a Yellow component color, or a Black component color. As further described below, in various such embodiments, the color gamut is two dimensional. As further described below, in various such embodiments, the color gamut is three dimensional. As further described below, in various such embodiment, the predefined area on the color gamut is two dimensional and circular and has a radius from the center point that has a length equal to the difference between minimum and maximum percentages of the predominate first color divided by two. As further described below, in various such embodiments, the predefined area on the color gamut is two dimensional and circular and has a radius defined by a standard deviation of the predominate first color. As further described below, in various other such embodiments, two standard deviations define the radius. As further described below, in various such embodiments, the predefined area on the color gamut is two dimensional and circular and has a static radius extending from the center point. As further described below, in various such embodiments, the static radius has a length equal to 13% of a value of a component color at the center point. As further described below, in various such embodiments, the predominate first color can vary in one of shade and hue with average variations of the predominated first color including the center point on the color gamut. As further described below, in various such embodiments, the predominate first color is one of shade and hue with mean variations of the predominate first color including the center point on the color gamut.

As further described below, in various other embodiments, the present disclosure provides a lottery ticket including a substrate, winning indica printed on the substate, non-winning variable indicia printed on the substrate, and a first scratch off coating covering the non-winning variable indicia. The winning indicia includes a first color, the first color including at least fifty percent of a predominate first color element. The non-winning variable indicia including a second color, the second color include at least fifty percent of the predominate first color element. As further described below, in various such embodiments, the first color of the winning indicia comprises less than fifty percent of a second color element, and wherein the second color of the non-winning variable indicia comprises less than fifty percent of a third color element, the second color component being different than the third color element.

Various embodiments and advantages of the present disclosure are further set forth in the following description, or may be apparent from the present description, or may be learned through practice of the present disclosure. Described herein are also a number of printing mechanisms and methodologies that provide practical details for reliably producing full-color secure indicia under a SOC that are highly resistant to microscratch attacks for SOC protected documents such as but not limited to SOC lottery tickets. As can now be appreciated in view of the previous summary of the present disclosure, in various embodiments, printing microscratch secure instant lottery tickets with full-color indicia, if the winning indicum is known, is achieved by printing at least one non-winning indicia similarly colored to the winning indicum under the SOC so that any microscratch attack will reveal a small portion of the non-winning indicia that resembles the winning indicium. So long as at least some non-winning indicia are similarly colored to the winning indicum a countermeasure to microscratching is achieved for at least the reasons described above and below.

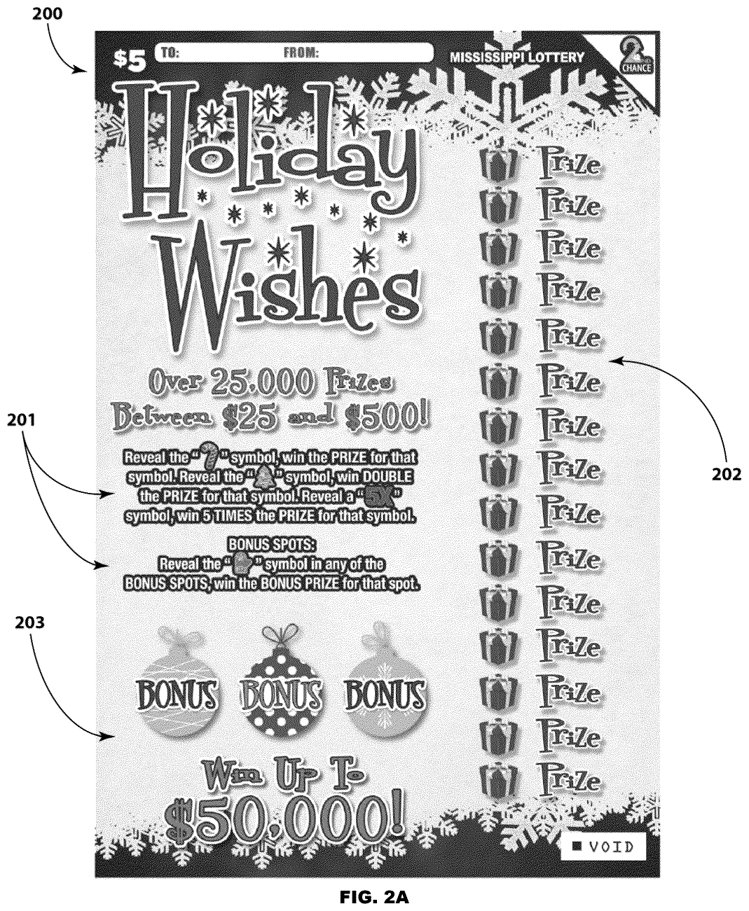

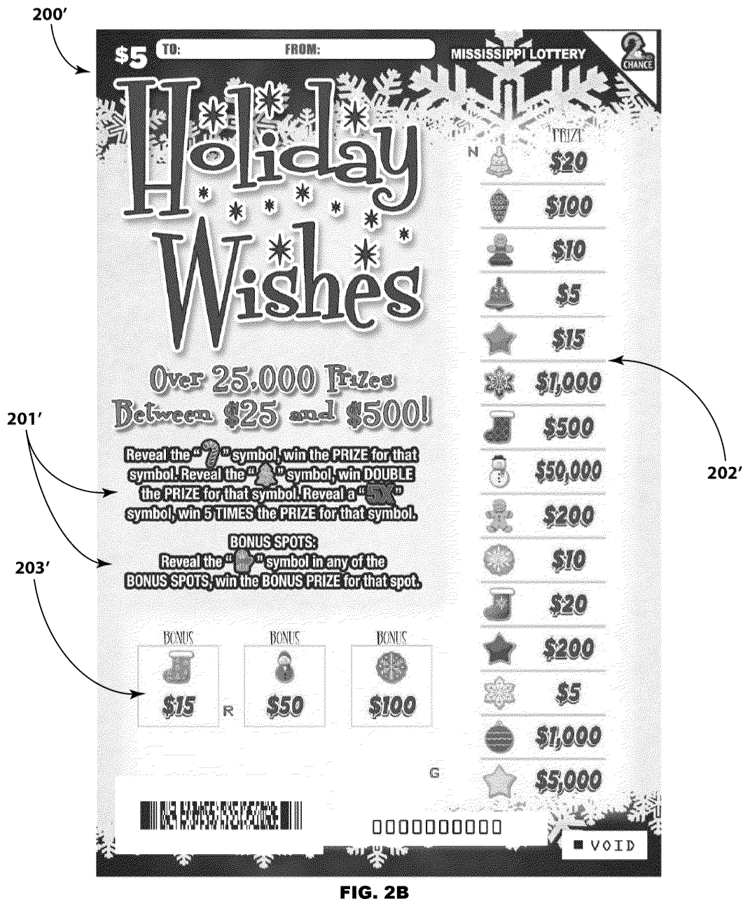

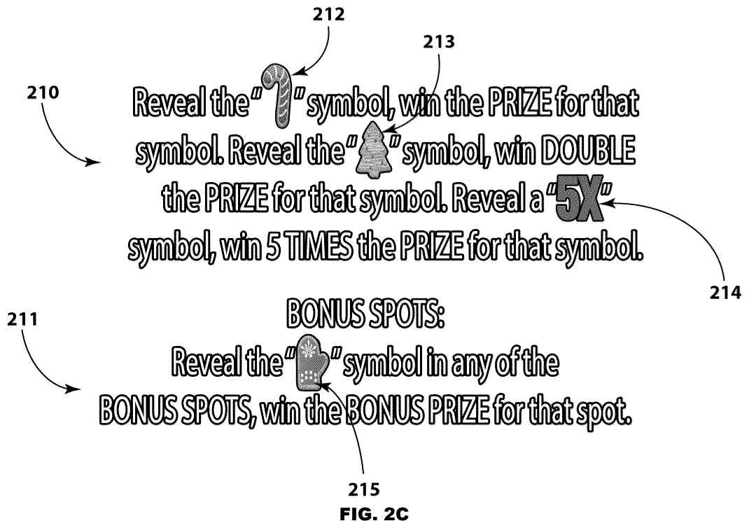

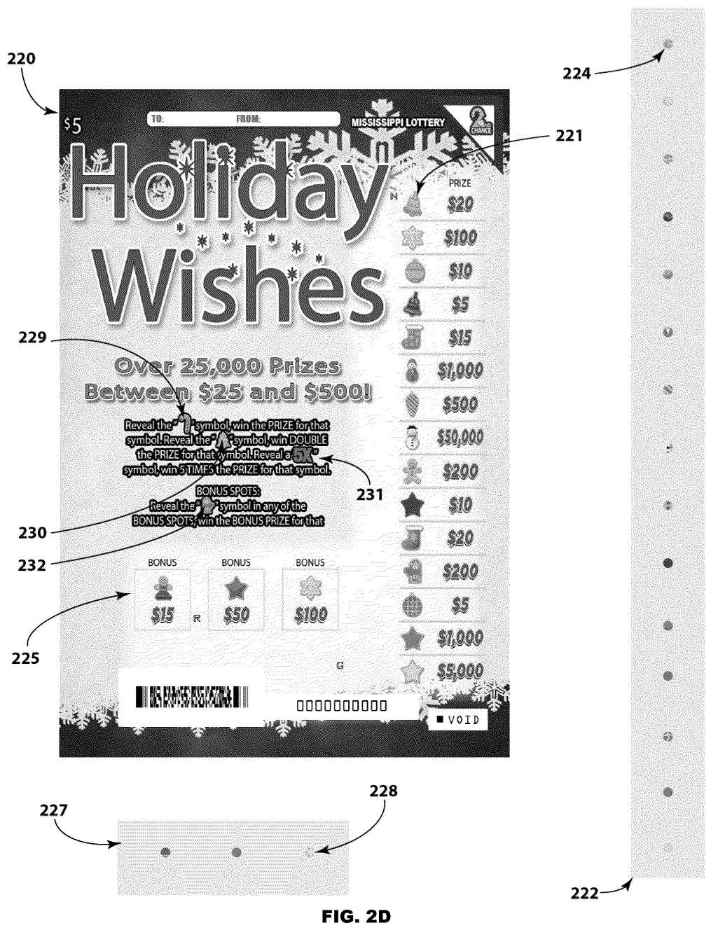

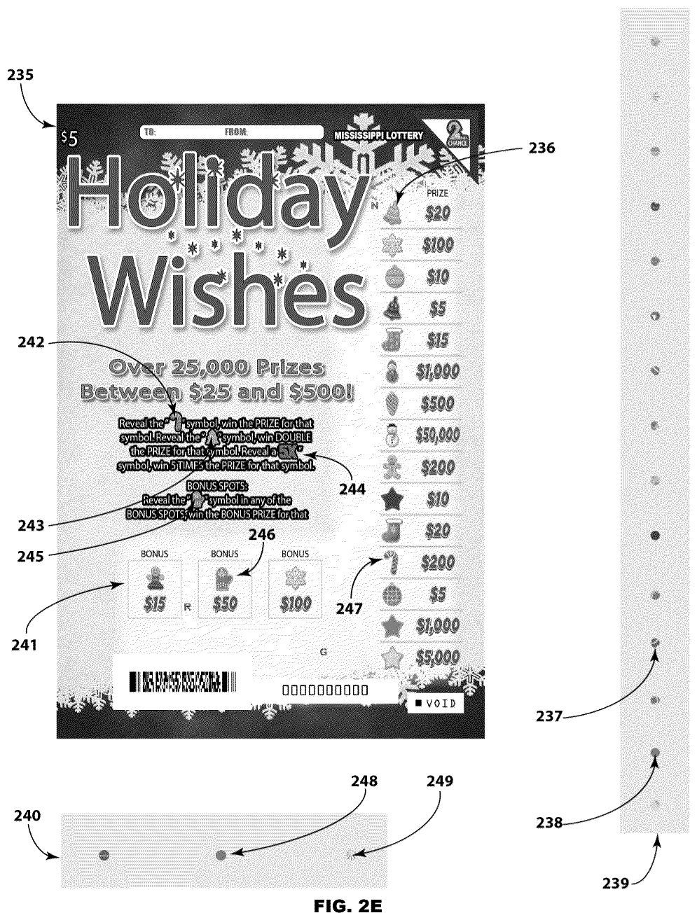

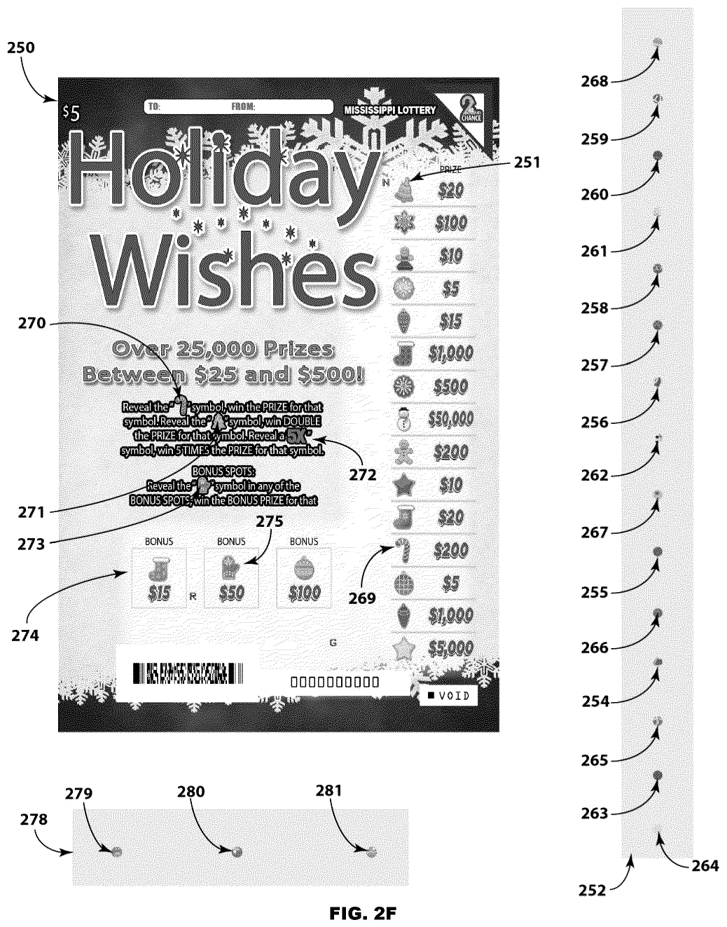

For example, FIGS. 2A thru 2F taken together, provide a detailed example specific countermeasure to microscratch attacks for full-color instant ticket “key match” games. FIG. 2A illustrates a front elevation view of an exemplary “key match” lottery ticket design shown in pristine condition. FIG. 2B illustrates the same exemplary “key match” lottery ticket in a fully scratched and played condition. FIG. 2C is a magnified view of the instruction portion of the same “key match” lottery ticket, highlighting the winning “key match” indicia for the lottery game. FIG. 2D provides an exemplary front elevation view of a “key match” lottery ticket with detailed magnified views of portions of interest including microscratched pin-prick holes through areas of the SOC on a non-winning lottery ticket that is not in compliance with the present disclosure for comparison purposes. FIG. 2E shows an exemplary front elevation view of a “key match” lottery ticket with detailed magnified views of portions of interest including microscratched pin-prick holes through areas of the SOC on a winning ticket that is also not in compliance with the present disclosure for comparison purposes. FIG. 2F illustrates an exemplary front elevation view of a “key match” lottery ticket with detailed magnified views of portions of interest including microscratched pin-prick holes through areas of the SOC on a winning lottery ticket that is in compliance with various embodiments of the present disclosure.

As shown in FIGS. 2A and 2B, the exemplary “Holiday Wishes” instant ticket 200 and 200′, respectively before and after the SOC is removed includes instructions 201 and 201′, respectively where the “key match” winning indicia 212, 213, 214, and 215 (shown in the magnified view of FIG. 2C) are in plain view on an unsold pristine lottery ticket 200 of FIG. 2A. This exemplary ticket includes two SOC areas 202 and 203 covering a vertical column of main play indicia 202′ as shown in FIG. 2B as well as a separate bonus play indicia 203′ area. The associated magnified view of FIG. 2C illustrates the main game instructions 210 (clearly visible on the unsold lottery ticket) with its associated three “key match” winning indicia 212, 213, and 214 thus identifying the only three indicia that can possibly win a prize in the main game. In this example, all other variable indicia appearing in the main game play column 202′ of FIG. 2B are, by definition for a “key match” game, non-winning indicia. The magnified view of FIG. 2C illustrates the separate bonus game instructions 211 with its one “key match” winning indicium 215 (e.g., the blue “mitten” indicium as shown in FIG. 2C) that is the only indicum that can possibly win a prize in the bonus game. In this example, all other variable indicia appearing in the bonus game play area 203′ of FIG. 2B are, by definition, non-winning indicia for that portion.

FIG. 2D depicts a representative example of a non-winning ticket 220 that is not in compliance with various embodiments of the present disclosure and is provided as an example of how non-winning “key match” full-color instant ticket embodiments that are not in compliance with various embodiments of the present disclosure can be readily susceptible to microscratch attacks. To better illustrate the concept of microscratching with full-color tickets FIG. 2D also includes magnified views 222 and 227 of example microscratch pin-prick holes through the SOC concealing the main game 224 (fifteen holes over underlying indicia) and bonus game 228 (three holes over underlying indica) portions.

As shown, the FIG. 2D exemplary lottery ticket shows its “key match” main game winning indicia 229, 230, and 231 and bonus game winning indicum 232 in the instructions portion of the lottery ticket and therefore readily evident on unsold pristine tickets. In this example, any nefarious attacker would know exactly which winning indicia to look for when microscratching the lottery ticket in advance of the physical microscratching process, which greatly simplifies the task. On an unsold pristine lottery ticket, the main game 221 and bonus game 225 portions would be covered by SOC (such as in FIG. 2A) which is simulated in magnified views 222 and 227 of FIG. 2D where the same variable indicia 221 and 225 appearing on the lottery ticket 220 are magnified and hidden behind the SOC in the two magnified SOC views 222 and 227. As is apparent from a casual view of the magnified microscratch pin-prick holes 224 in fifteen places, the absence of any red (229 “candy cane”) or green (230 “Christmas tree” and/or 231 “5×”) colors in the main game portion microscratch holes 224 in fifteen places readily identify that the main game portion of this example lottery ticket does not win any prizes. With the bonus game portion 227, it is also readily apparent from a casual view of the magnified microscratch pin-prick holes 228 in three places, the absence of any blue (232 “mitten”) color in the microscratch holes also identifies that this portion of this ticket does not win any prizes. Thus, if the exemplary instant ticket 220 were subjected to a microscratch pin-prick hole attack, it would be a relatively trivial matter for the nefarious attacker to ascertain that ticket 220 did not win any prizes and therefore should be placed available for sale to an unsuspecting public.

FIG. 2E also depicts a representative example of a winning ticket 235 that is not in compliance with various embodiments of the present disclosure. This is an example of how winning “key match” full-color instant ticket embodiments that are not in compliance with various embodiments of the present disclosure can be readily susceptible to microscratch attacks. To better illustrate the concept of microscratching with full-color tickets, FIG. 2E also includes magnified views 239 and 240 of microscratch pin-prick holes through the SOC concealing the main game 239 (fifteen indicia) and bonus game 240 (three indica) portions.

As shown, the FIG. 2E exemplary lottery ticket shows its “key match” main game winning indicia 242, 243, and 244 as well as bonus game winning indicum 245 in the instructions portion of the lottery ticket and therefore readily evident on unsold pristine tickets. In this example, any nefarious attacker would know exactly which winning indicia to look for when microscratching the lottery ticket in advance of the physical microscratching process. On a pristine lottery ticket, the main game 236 and bonus game 241 portions would be covered by SOC (such as in FIG. 2A) which is simulated in magnified views 239 and 240 of FIG. 2E where the same variable indicia 236 and 241 appearing on ticket 235 are magnified and hidden behind the SOC in the two magnified SOC views 239 and 240. As is apparent from a casual view of the magnified main game microscratch pin-prick holes 238 (in fifteen places), the winning red with a white stripe colors present in the main game portion 247 (“candy cane”) appear through microscratch hole 237 readily identifying that the main game portion of this lottery ticket wins a prize. With the bonus game portion 240 and 241 it is also readily apparent from a casual observation of the magnified microscratch pin-prick hole 248 that the blue “mitten” color appearing through microscratch hole 248 is identical to the color of the wining indicum 246 similarly indicating that the bonus portion of this lottery ticket also wins a prize. Thus, if the exemplary instant ticket 235 were subjected to a microscratch pin-prick attack, it would be a relatively trivial matter for the nefarious attacker to ascertain that lottery ticket 235 wins prizes and therefore should be purchased by the nefarious retailer attacker and subsequently redeemed, and consequently never offered for sale to the public.

Conversely, FIG. 2F depicts a representative example of a winning ticket 250 that is in compliance with one embodiment of the present disclosure as an example of how “key match” full-color instant ticket embodiments that are in compliance with various embodiments of the present disclosure provide countermeasures to microscratch attacks. To better illustrate the microscratching with full-color tickets, FIG. 2F also includes magnified views 252 and 278 of microscratch pin-prick holes through the SOC concealing the main game 252 (fifteen indicia) and bonus game 278 (three indica) portions.

As before, the FIG. 2F exemplary ticket 250 shows its “key match” main game winning indicia 270 thru 272 and bonus game winning indicum 273 in the instructions portion of the lottery ticket and therefore readily evident on unsold pristine lottery tickets. For example, any nefarious attacker would know exactly which winning indicia to look for when microscratching the lottery ticket in advance of the physical microscratching processes. On an unsold pristine lottery ticket, the main game 251 and bonus game 274 portions would be covered by SOC (such as in FIG. 2A) which is simulated in magnified views 252 and 278 of FIG. 2F where the same variable indicia 251 and 274 appearing on lottery ticket 250 are magnified and hidden behind the SOC in the two magnified SOC views 252 and 278. The lottery ticket's 250 winning “candy cane” indicum 269 predominate red color appears through its associated microscratch pin-prick hole 254 as before; yet with this embodiment, the microscratch pin-prick holes over similarly colored indicia 255 thru 259 now generate misperceptions for the microscratch attacker such that it is no longer obvious to a nefarious microscratch attacker whether this particular ticket 250 is a winner or not. This misperception greatly mitigates or eliminates any microscratch financial incentive. Additionally, several green indicia colored similar to the winning Christmas Tree 271 and/or winning “5×” 272 indicia also create supplementary misperceptions of whether this particular lottery ticket 250 is a winner or not when viewed through magnified microscratch pin-prick holes 260 thru 263. The remaining microscratch holes 264 thru 268 cover indicia that are not colored similarly to winning indicia 270 thru 272 and are consequently provided for variety and other purposes, but do not contribute significant misperception in terms of countermeasures to microscratching for full-color tickets.

With the bonus game portion 274, the presence of the blue 275 winning “mitten” color appearing through microscratch hole 280 is also camouflaged by the two similarly colored non-winning indicia appearing through microscratch holes 279 and 281. Again, the addition of the two similarly colored non-winning indicia in the bonus area 274 creates sufficient misperception in accordance with the present disclosure such that a microscratch pin-prick attacker can no longer reliably determine if a particular lottery ticket is a winner.

Consequently, with the previously described embodiment, a full-color “key match” game with winning indicia readily displayed on unsold pristine tickets can be made relatively secure against microscratching attacks by ensuring that there is at least one non-winning indicium that is colored similarly to at least one corresponding displayed winning indicum on a large majority of or every non-winning lottery ticket. In an alternate embodiment, at least two indicia that are colored similarly to each corresponding displayed winning indicum can be printed on every lottery ticket. In various embodiments, “similarly colored” non-winning indicia are more desirable than identically colored non-winning indicia. This “similarly” colored requisite is to enable greater freedom with lottery ticket art design. Additionally, various full-color variable indicia (both winning and non-winning) are configured with multiple colors and shades—i.e., various process colors are included with one or two predominate colors dominating most full-color indicia. For example, the displayed winning indicia of FIG. 2F are illustrated as a dual process color (red and white) “candy cane” 270, a multi-shaded green colored “Christmas tree” 271, and a multiple colored (shades of blue and white) “mitten” 275 with only the “5×” full-color winning indicium illustrated as a monochromatic process color green.

In the context of the present disclosure, the term “predominate color(s)” may refer to the color or colors that are printed within the majority of an indicium's surface area. With most indicia (e.g., 270 thru 273 of FIG. 2F), the majority of the surface area would simply be defined as the color or colors that are printed over at least 50% of the indicia's surface. However, with some indicia, the majority of the surface area would be defined as the color or colors that are printed that are covering more of the indicium's surface area than any one single color from a plurality of other colors. For example, a color covering only 40% of an indicium's total surface area would be the predominate color if there were three other colors printed on the indicum surface each covering only 20% of the total surface area.

The “predominate color” may be monochromatic (i.e., one color) such as the “5×” indicum 272 or a multichromatic collection of generally related hues such as the “Christmas tree” indicum 271. As illustrated in indicum 270 and 273, there may be other colors present within a given indicum, but the “predominate color” will denote the color or colors covering the largest surface area of a given indicum. For example, red for the “candy cane” indicum 270 and blue for the “mitten” indicum 273.

Thus, to ensure that this embodiment is applicable to as broad a set of full-color lottery tickets as possible, it is desirable for the predominate colors of the non-winning indicia to be similar to the predominate colors of the correlated winning indicia rather than an exact color match. While it is arguably readily apparent to most observers whether two colors or similar or not, it is nevertheless problematic when attempting to define metrics for similar colors compatible with this embodiment. Consequently, various embodiments of the present disclosure define the predominate color(s) of the known winning indicia and the corresponding predominate color(s) of the non-winning indicia with specific metrics thereby enabling analytical parameters to determine if the known winning indicia colors and the non-winning indicia colors would appear to be similar or identical under a microscratch attack.

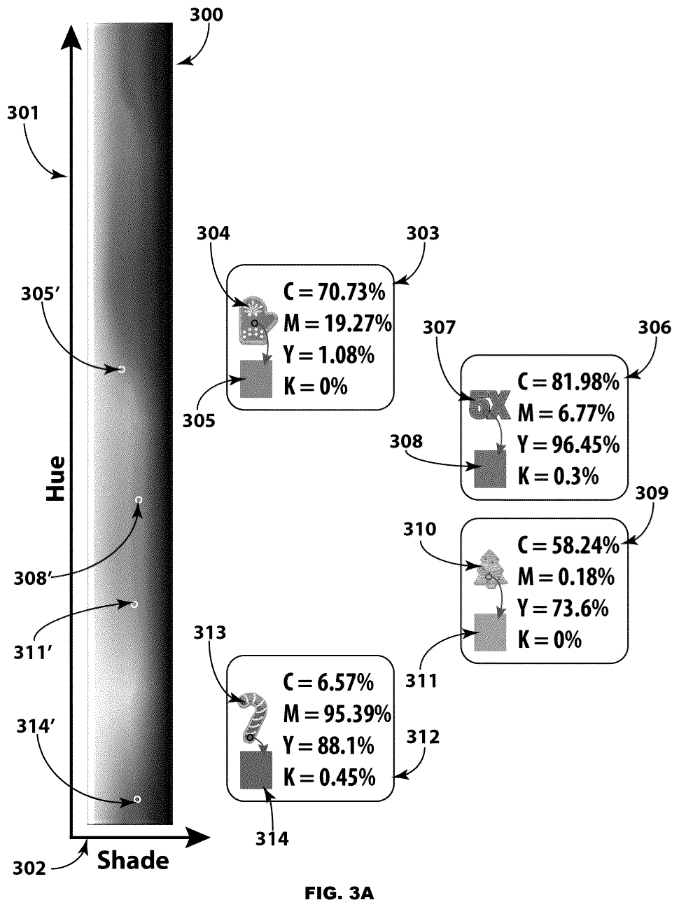

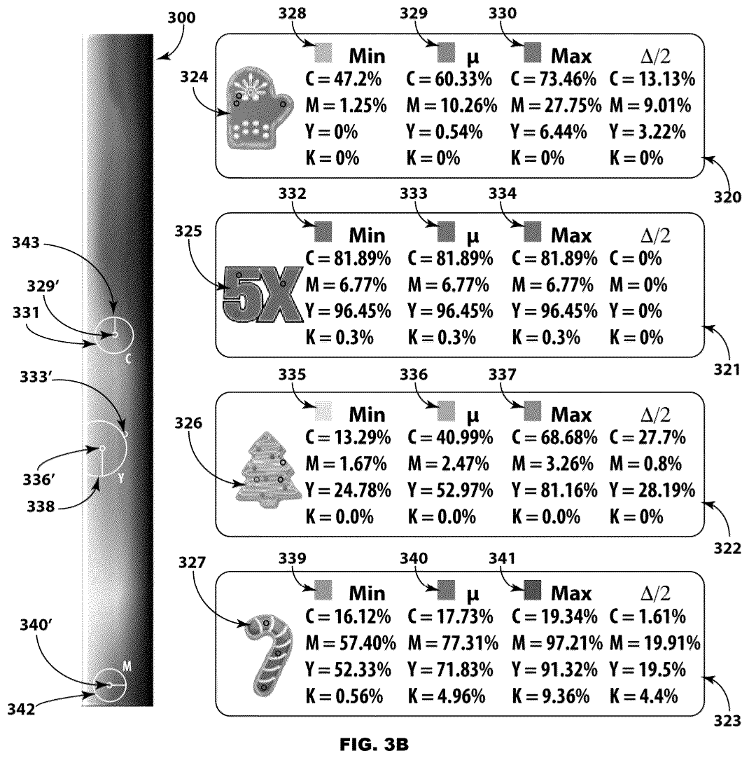

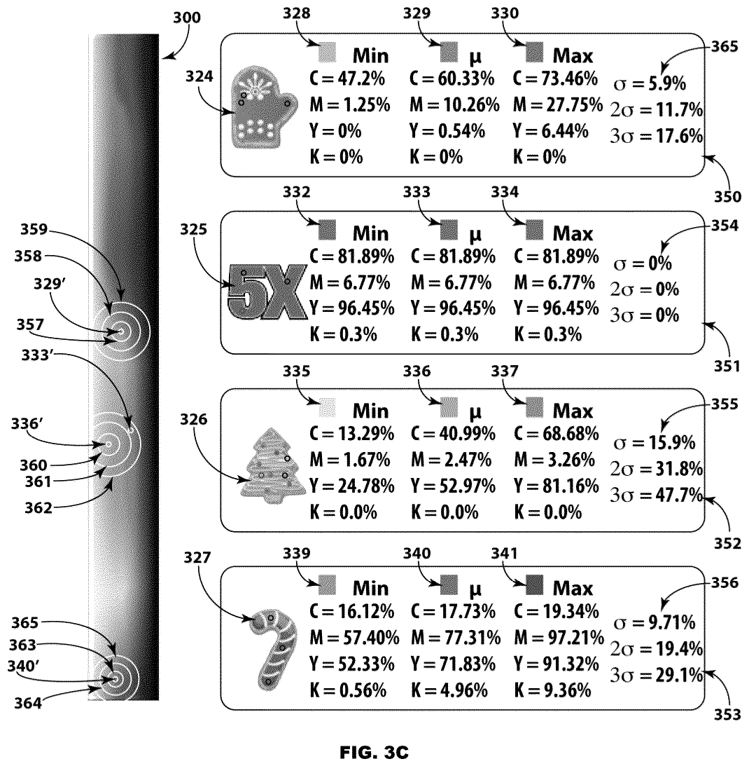

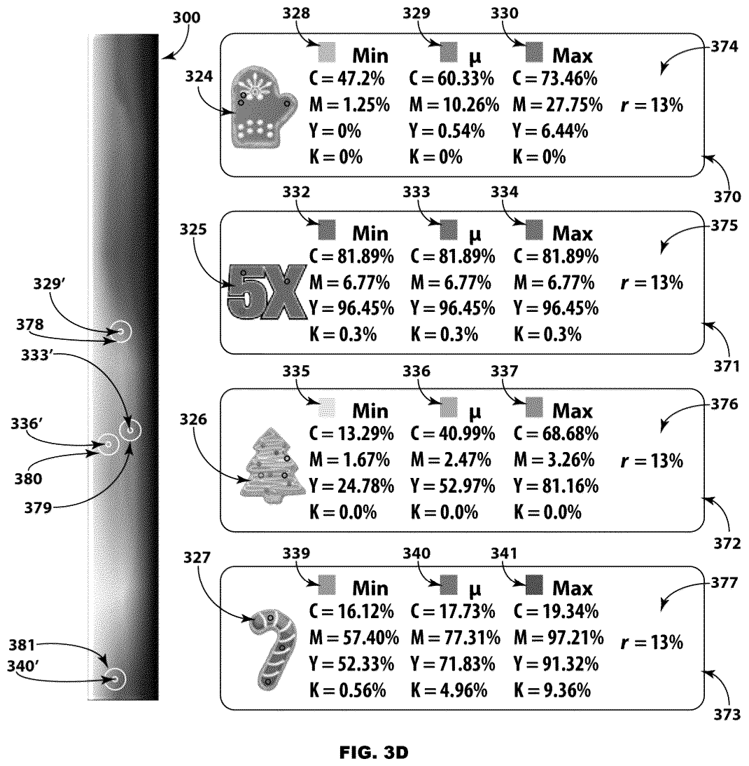

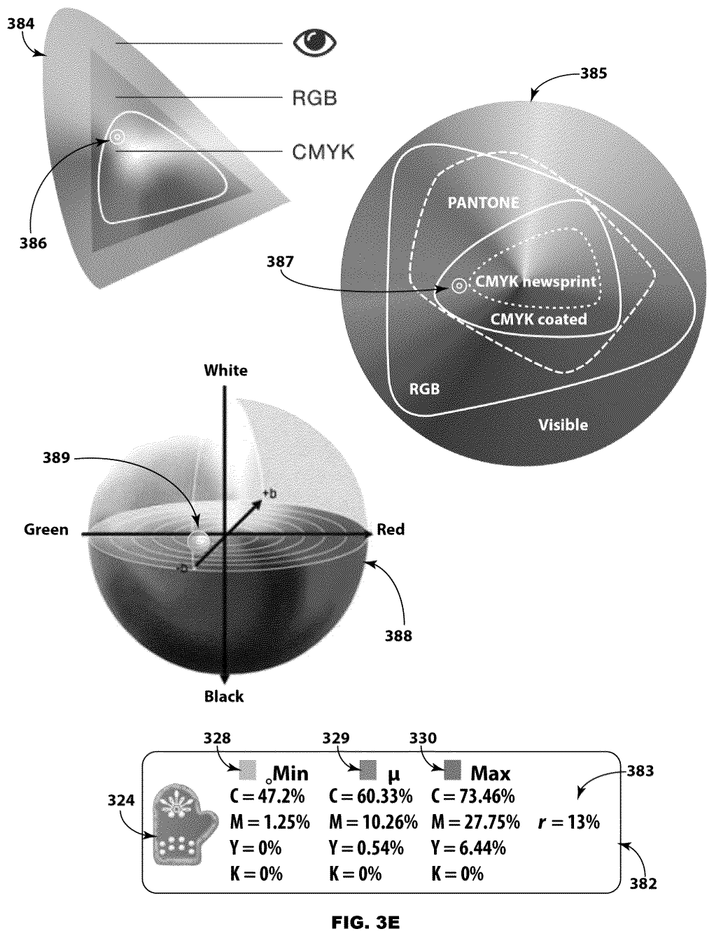

Full-color or process color tickets are produced by imaging a variety of colors in discrete combinations of primary component color inks. While there are multiple combinations of primary component inks available for process colors, the most common combination is “CMYK”—i.e., mixtures of Cyan, Magenta, Yellow, and black inks. FIG. 3A illustrates a typical CMYK imager's color gamut 300. A color gamut graphically shows the subset of process colors that can be accurately produced by a given printer (e.g., CMYK printer), thereby illustrating the printer's color space or range of colors that can be actually reproduce. While there are multiple ways of illustrating color gamuts, the color gamut 300 of FIG. 3A is arranged as a “flattened” three-dimensional band (i.e., the top and bottom of color gamut 300 are conceptually connected thereby creating a continuous band of color space) with the amount of shading increasing from zero to maximum on the horizontal axis or abscissa 302 and the hue mostly changing from the longest to the shortest wavelength of reflected light on the vertical axis or ordinate 301. The hue 301 is determined by the amount of each primary component color ink pigment imaged (e.g., CMY) to create a given process color, which in turn determines the wavelength(s) of light reflected off of the printed process color that are ultimately perceived by the human eye. The shade 302 is the hue 301 mixed with varying quantities of black (e.g., K) or sufficient quantiles of the three primary component colors (e.g., CMY) to resemble black. Thus, all of the process colors appearing in gamut 300 are in reality a combination of CMYK inks applied in varying quantities.

For example, the winning “mitten” indicium 275 of FIG. 2F is reproduced 304 in FIG. 3A with its predominate blue color highlighted 305. Callout 305′ pinpoints where this predominate blue process color 305 appears in color gamut 300. As shown in FIG. 3A, the amount of CMYK ink 303 that is printed to produce this predominate blue process color 305 is: 70.73% of cyan, 19.27% of magenta, 1.08% of yellow, and 0% of black. The printing convention of percentages (i.e., a scale of 0% to 100%) displayed in FIG. 3A conveys how much ink is applied for a given process color with a value of 0% denoting white (i.e., no ink applied, white paper) and a value of 100% denoting total ink saturation. Thus, the predominate blue process color 305 is primarily comprised of cyan (70.73%) with some magenta (19.27%), very little yellow (1.08%), and no black (0%) ink. It should be noted that the predominate blue process color 305 was selected to represent the typical blue color of the indicium 304 and is not representative of all shades of blue appearing in indicum 304. In other words, a careful inspection will reveal that the shade of blue fades, over a limited range, to gradually darker progressing from left-to-right within indicum 304. This is an example of why choosing a range of similar colors for the non-winning indicia to mimic the actual predominate process color of the winning indicium is superior in various embodiments of the present disclosure to attempting to reproduce the winning indicum predominate color exactly. In other words, it may be possible to pick-out non-winning indicia produced with the exact same predominate process color when the winning indicum is actually comprised of a range of process colors.

This same general concept can be extended to the other winning indicia of FIG. 2F—i.e., in FIG. 3A the “5×” 307, “Christmas tree” 310, and the “candy cane” 313 indicia. With the monochromatic “5×” indicum 307, the predominate color 308 is not an average but instead representative of the entire homogeneous green indicum 307. The location of the “5×” indicum 307 predominate color 308 on the color gamut 300 is shown as 308′ with the associated CMYK inks applied 306 to reproduce the predominated color 308 as component colors with the following percentages: 81.98% cyan, 6.77% magenta, 96.45% yellow, and 0.3% black. The heterogeneous “Christmas tree” indicum 310 has a typical predominate color 311 with a very wide variant. The location of the “Christmas tree” indicum 310 predominate color 311 on the color gamut 300 is shown as 311′ with the associated CMYK inks applied 309 to reproduce the predominated color 311 as component colors with the following percentages: 58.24% cyan, 0.18% magenta, 73.6% yellow, and again 0% black. Finally, the heterogeneous “candy cane” indicum 313 has a typical predominate color 314 with a variant—i.e., the shade and saturation of the red color mostly decreases from the bottom of the indicum 313 to the top. The location of the “candy cane” indicum 313 predominate color 314 on the color gamut 300 is shown as 314′ with the associated CMYK inks applied 312 to reproduce the predominated color 314 as component colors with the following percentages: 6.57% cyan, 95.39% magenta, 88.1% yellow, and 0.45% black. Thus, all of the printable colors of the variable indicia can be equated to percentages of CMYK that appear in a specific location on the associated color gamut 300. The issue then remains of how to establish metrics for ascertaining if a given color is “similar” to the predominate color or not.

FIG. 3B illustrates one example embodiment for analytically defining “similarity” of colors utilizing the two-dimensional color gamut 300 of FIG. 3A. In FIG. 3B, each of the four winning indicia from FIG. 2F are shown with their associated metrics in groupings 320 thru 323 of FIG. 3B. The four winning indicia 324, 325, 326, and 327 are illustrated magnified with the areas of interest denoted by small two-dimensional circles identifying three different points within each indicum where its predominate color is printed in minimum, maximum, and (approximately) mean average (typically abbreviated by the Greek letter mu, “μ”) color CMYK ink saturation levels—i.e., the points where the minimum, maximum, and average (μ) amounts of CMYK ink are printed within each indicum.

Starting with the winning “mitten” indicum 324 of grouping 320, the minimum (Min) CMYK metrics and associated color 328 are shown in the first column followed by the mean average (μ) color 329 and correlated CMYK metrics in the next column with the maximum (Max) color 330 and related CMYK metrics listed in the next column. The far-right column lists the difference (typically abbreviated by the Greek letter delta “Δ”) between the Min and Max CMYK metrics divided by two, which as will be shown constitutes the radius of a circle defining the area of “similar” color on the two-dimensional color gamut 300.

The Min column of CMYK metrics defines the minimum amount of component color ink 328 (in percent) that is printed within indicum 324 in terms of variations of the predominate process color (blue). The Max column of CMYK metrics defines the maximum amount of component color ink 330 that is printed within indicum 324 in terms of variations of the predominate process color. The mean average (μ) column of CMYK metrics defines the theoretical average amount of component color ink 329 that is printed within indicum 324 in terms of variations of the predominate process color, the point where this average (μ) distribution of process color ink falls on the two-dimensional color gamut 300 is identified by callout 329′.

With this example embodiment, a “similar” process color relative to the predominate process color is defined as falling within a circular static color space or predefined area (e.g., 331) on the two-dimensional color gamut 300 centered around the point of the mean average (μ) CMYK predominate process color (e.g., 329′). The radius (e.g., 343) of this circular color space or predefined area (e.g., 331) on the two-dimensional color gamut 300 is the delta divided by two (Δ/2) value as quantified by the “dominate component color” (e.g., cyan for radius 343). The radius is drawn on the two-dimensional color gamut 300 in this embodiment by constructing a line 343 from the mean average (μ) CMYK predominate process color (e.g., 329′) to the Max “dominate component color” value on color gamut 300.

The term “dominate component color” in this context refers to the component color (e.g., cyan, magenta, yellow, or black) with the greatest Max value (cyan in group 320). With this example embodiment, it has been found that defining the “similar” process color space exclusively in terms of the dominate color provides a reasonable approximation of “similar” colors for the purposes of microscratching countermeasures with the advantage of simplified calculations. For the special case where two or more component colors exhibit the same greatest Max value (e.g., rich black), the delta divided by two (Δ/2) radius calculation will still produce satisfactory results so long as the greatest Max value for a single color is selected.

In the specific example of indicum 324, the point where the μ CMYK process color 329′ falls onto the two-dimensional color gamut 300 is surrounded by circle 331 that is described by the radius 343 extending from the μ point 329′ where the radius 343 is the dominate component color's Δ/2 value—13.13% in this example. Thus, so long as any process color falls within the color space contained within circle 331 it can be considered a “similar” color to indicium's 324 dominate color for the purposes of microscratching countermeasures.

Continuing the discussion of FIG. 3B with the winning “5×” indicum 325 of grouping 321, the Min CMYK metrics and associated color 332 are shown in the first column followed by the μ color 333 and correlated CMYK metrics in the next column with the Max color 334 and related CMYK metrics listed in the next column. As before, the far-right column lists the A or difference between the Min and Max CMYK metrics divided by two; however, in the special case of indicium 325 its predominate process color is monochromatic (i.e., the same process color and shade throughout the indicum), which accounts for the Δ/2 values of 0% for all four CMYK component colors. Thus, with the specific example of indicum 325, the μ predominate process color is shown as only a point 333′ on the two-dimensional color gamut 300 with no corresponding “similar” color space as disclosed by this embodiment. In other words, since the predominate process color is monochromatic throughout the indicum, its entire color range is represented as a single point rather than an average.

With the winning “Christmas tree” indicum 326 of grouping 322, the Min CMYK metrics and associated color 335 are shown in the first column followed by the μ color 336 and correlated CMYK metrics in the next column with the Max color 337 and related CMYK metrics listed in the next column. The far-right column lists the A or difference between the Min and Max CMYK metrics divided by two showing wide variances for both the cyan (27.7%) and dominate yellow (28.19%) component colors. These wide variances are due to the various shades of green contained inside indicum 326. Consequently, the correlated “similar” color space centered at point 336′ and contained by circle 338 within the two-dimensional color gamut 300 has a larger radius (28.19%) that is partially flattened on its left-hand side. This partial flattening of the circular “similar” color space is due to the percentage printing convention that has an inherent limited range of 0% to 100%. For example, 0% is white paper with no ink applied and therefore negative percentage values simply do not make sense in this context. While not present with indicum 326, a likewise flattening can theoretically occur on the right-hand side of an otherwise circular color space when the process color is completely saturated (i.e., 100% black or 100% CMYK).

Finally, with the winning “candy cane” indicum 327 of grouping 323, the Min CMYK metrics and associated color 339 are shown in the first column followed by the μ color 340 and correlated CMYK metrics in the next column with the Max color 341 and related CMYK metrics listed in the next column. As before, the far-right column lists the A between the Min and Max CMYK metrics divided by two showing almost identical variances for the dominate magenta (19.91%) and yellow (19.5%) component colors. The point where the μ CMYK process color 340′ falls onto the two-dimensional color gamut 300 is surrounded by circle 342 defining the “similar” process colors for this indicium.

Therefore, in this “dominate component color” embodiment, a “similar” process color relative to the predominate process color is defined as any process color falling within a circular static color space or predefined area (e.g., 331) on the color gamut plane (e.g., 300) centered around the point of the mean average (μ) CMYK predominate process color (e.g., 329′). The radius (e.g., 343) of this circular color space or predefined area (e.g., 331) on the color gamut plane is described as the delta divided by two (Δ/2) value of the “dominate component color” (e.g., cyan for radius 343).

FIG. 3C illustrates a second example embodiment for analytically defining “similarity” of colors utilizing the two-dimensional color gamut 300 of FIG. 3A. FIG. 3C is arranged like FIG. 3B with the four winning indicia shown with their associated metrics in groupings 350 thru 353. As before, the four winning indicia 324, 325, 326, and 327 are illustrated magnified with areas of interest identifying three different points of predominate color within each indicum where the Min, Max, and (approximately) mean average (μ) color CMYK ink saturation levels are collected.

Starting with the winning “mitten” indicum 324 of grouping 350, the CMYK metrics Min, Max, and u colors are identical to the example of FIG. 3B. However, in FIG. 3C the far-right column lists the standard deviation 365 (typically abbreviated by the Greek letter sigma, “o”) for all of the printed pixels comprising the predominate process color for indicium 324—i.e., all of the cyan, magenta, yellow, and black printed pixels combined together in the single standard deviation (σ) calculation. Thus, in this example embodiment, there is no “dominate component color” selected, rather all of the component colors (e.g., CMYK in this example) contribute to the definition of the “similar” circular color space or predefined area.

In statistics, the standard deviation (σ) for a population is a measure that is used to quantify the amount of variation or dispersion of a set of data values. A standard deviation close to zero indicates that the data points tend to be very close to the mean (μ) of the set, while a high standard deviation indicates that the data points are spread out over a wider range of values. For the normal (Gaussian) distribution that is typical of component ink printed pixels that comprise a process color, the values less than or equal to one standard deviation (σ) away from the mean (μ) account for 68.27% of the given indicum component color's printed pixels. Two standard deviations (2σ) from the mean (μ) account for 95.45% of the given indicum component color's printed pixels. Finally, three standard deviations (3σ) account for 99.73% of the given indicum component color's printed pixels.

Returning to the winning “mitten” indicum 324 of the grouping 350 example, the μ CMYK process color 329′ falls onto the same two-dimensional color gamut 300 location as in FIG. 3B; however, in FIG. 3C, it is bounded by one standard deviation (σ) circle 357, 2σ circle 358, and 3σ circle 359. From a cursory examination, it can be readily seen that the 2σ circle 358 roughly prescribes approximately the same color space or predefined area as the “dominate color” model of the previous embodiment—i.e., a radius of 11.7% for the 2σ circular color space 358 verses a radius of 13.13% for the “dominate component color” circular color space 331 of FIG. 3B. Thus, it would appear that the one σ circular color space 357 (FIG. 3C) is too restrictive and the 30 circular color space 359 is too broad with the 2σ circular color space 358 providing the best approximation for “similar” color matching. The radius is drawn on the two-dimensional color gamut 300 in this embodiment by constructing a line from the mean average (μ) CMYK predominate process color (e.g., 329′) to the plus one sigma (σ) value for the component colors (e.g., 66.23% for the color cyan contained in grouping 350). The 2σ and 3σ radiuses are two and three times the one sigma (σ) value, respectively.

Moving onto the winning “5×” indicum 325 of the grouping 351 example, the μ CMYK process color 333′ again falls onto the same two-dimensional color gamut 300 location as before. Though, since the “5×” indicum predominate process 325 color is monochromatic throughout the indicium, the one σ, 2σ, and 3σ values 354 are all zero (i.e., no variance because of the monochromatic process color used throughout the indicium) and consequently as before no “similar” colors were defined in this example embodiment.

With the winning “Christmas tree” indicum 326 of the grouping 352 example the μ CMYK process color 336′ falls onto the same two-dimensional color gamut 300 location as before bounded by σ circle 360, 2σ circle 361, and 3σ circle 362 given by their standard deviations 355. While the 2σ circle 361 is roughly the same color space as the “dominate component color” model of the previous embodiment (i.e., a radius of 31.8% for the 2σ circular color space 361 verses a radius of 28.19% for the “dominate component color” circular color space 338 of FIG. 3B) the 2σ circular color space 361 is slightly larger due to the wide color variance of the predominate process color in the “Christmas tree” indicum.

Lastly, with the winning “candy cane” indicum 327 of the grouping 323 example the μ CMYK process color 340′ is in the same two-dimensional color gamut 300 location as before bounded by σ circle 363, 2σ circle 364, and 3σ circle 365 given by their standard deviations 356. In this example, the 2σ circle 364 is almost the exact same color space or predefined area as the “dominate component color” model of the previous embodiment—i.e., a radius of 19.4% for the 2σ circular color space 364 verses a radius of 19.91% for the “dominate component color” circular color space 342 of FIG. 3B.

Thus, in the standard deviation embodiment, a “similar” process color relative to the predominate process color can be defined as any process color falling within a circle on the color gamut plane (e.g., 300) where the circle has a radius of two standard deviations (2σ) centered at the point of the mean average (μ) CMYK predominate process color (e.g., 340). Thus, the standard deviation embodiment of “similar” process colors has the advantage of incorporating every component color (e.g., CMYK) into its calculations for the defined area for “similar” process colors with the disadvantage of added complexity.

FIG. 3D illustrates a third example embodiment for analytically defining “similarity” of colors utilizing the color gamut 300 plane of FIG. 3A. FIG. 3D is arranged as before with the four winning indicia shown with their associated metrics in groupings 370 thru 373. The four winning indicia 324, 325, 326, and 327 are illustrated magnified with areas of interest identifying three different points of predominate color within each indicum where the Min, Max, and (approximately) mean average (μ) color CMYK ink saturation levels are collected.

With the winning “mitten” indicum 324 of grouping 370 the CMYK metrics Min, Max, and u colors are identical to the example of FIG. 3B. However, in FIG. 3D the far-right column lists a static exemplary 374 radius (r) of 13% describing a circle of “similar” colors in the color gamut 300. While representative, this 13% radius (r) value was selected as a conservative example for a static assigned radius but may not be considered as optimized for all applications. In some examples, a less conservative radius (e.g., 17%, 19%, 25%) may be found to be more desirable. Thus, this embodiment employs a static assigned radius (r) describing a circular color space in the color gamut 300 plane in theory (i.e., for all winning indicia 374 thru 377 in FIG. 3D) and therefore independent of the distribution or makeup of the component colors.

Returning to the winning “mitten” indicum 324 of the grouping 370 example, the μ CMYK process color 329′ falls onto the same two-dimensional color gamut 300 location as in FIG. 3B. However, in FIG. 3D it is described by a static radius (r) circle 378 of 13%. The static radius circle (r) of 13% providing a conservative approximation for “similar” color matching as a general theoretical principle and not dependent on the composition of the indicum 324 component colors.

The impact of the static radius circle (r) embodiment can be most appreciated when viewed in context of the winning “5×” indicum 325 of the grouping 371 example. As before, the μ CMYK process color 333′ again falls onto the same two-dimensional color gamut 300 location, but in this particular embodiment even though the “5×” indicum predominate process 325 color is monochromatic, the static radius (r) circle of 13% nevertheless defines an area of “similar” colors 379 on the gamut plane 300. This is the only embodiment described in detail that provides a defined area of “similar” colors on the gamut plane even if the indicum is monochromatic (e.g., 325).

With the winning “Christmas tree” indicum 326 of the grouping 376 example the μ CMYK process color 336′ falls onto the same two-dimensional color gamut 300 location as before bounded by the static radius (r) circle 380 of 13%. As can be seen from a brief overview of the color gamut plane 300, the circular area of “similar” colors is limited in this example. With the winning “candy cane” indicum 327 of the grouping 373 example the μ CMYK process color 340′ is in the same two-dimensional color gamut 300 location as before bounded by the static radius (r) circle 381 of 13%.

Thus, with this static radius embodiment, a “similar” process color relative to the predominate process color can be defined as any process color falling within a circle on the color gamut plane (e.g., 300) where the circle has an theoretical assigned static radius (r) centered about the mean average (μ) of the component colors (e.g., CMYK). This embodiment has the advantages of simplicity and inclusiveness of monochromatic indicia in defining “similar” process colors with the disadvantage of a static “similar” process color space that does not necessarily conform with the predominate process color.

It should be appreciated that the present disclosure contemplates that there are alternative color gamut structures that are not necessarily planar nor rectangular. For example, FIG. 3E illustrates three alternate color gamut structures 384, 385, and 388 that differ from the planar rectangular gamut structure 300 of FIGS. 3A thru 3D. Nevertheless, the three previously disclosed example embodiments for describing “similar” process colors in a defined space or predefined area on a color gamut are compatible with the three alternate gamut structures of FIG. 3E as well as all other gamut structures.

The two-dimensional horseshoe shaped color gamut 384 is structured to show all colors perceived by the human eye while also illustrating the possible colors for an additive light (i.e., Red, Green, and Blue or “RGB”) color model in the triangular color space with the printable CMYK color space illustrated as a subset of the additive RGB space. As shown in color gamut 384, the “similar” process colors for the winning “mitten” indicum 324 of grouping 382 can be mapped 386 onto two-dimensional color gamut 384 by first locating the μ CMYK center and then extending the defined radius 383 over a portion of color gamut 384.

Three-dimensional conical shaped color gamut 385 (illustrated “flattened” in FIG. 3E) is structured to also show all colors perceived by the human eye as well as the printable colors possible with CMYK newsprint, CMYK coated stock (typical of instant tickets), predefined Pantone® color swatches, and additive RGB colors. In this example, the “similar” process colors for the winning “mitten” indicum 324 of grouping 382 color space or predefined area can be mapped 387 onto the surface of the three-dimensional conical shaped color gamut 385.

Finally, three-dimensional spherical color gamut 388 also shows all colors perceived by the human eye as well as CMYK printable colors and additive RGB colors. In this example, the “similar” process colors for the winning “mitten” indicum 324 of grouping 382 color space can be mapped 389 as a three-dimensional sphere contained within the spherical color gamut 388.

Having described selecting “similar” predominate colors of winning and non-winning indicia that are the primary countermeasures against microscratch attacks in SOC secured full-color tickets, the present disclosure will now address selecting “similar” patterns of objects embedded within variable indicia as a secondary countermeasure. Theoretically, embedded variable indicia patterns provide less of a vulnerability to microscratch attacks than colors since embedded patterns generally require a greater area of SOC to be removed to ascertain an indicum pattern then to determine if an indicum exhibits a given predominate color. In other words, as shown in FIGS. 2D thru 2F, it is possible to determine the predominate color of an indicum with one microscratch pin-prick hole; however, microscratch pattern recognition typically requires a relatively close plurality of pin-prick holes, surreptitious slices, or a combination of a plurality of pin-prick holes and surreptitious slices to successfully identify a given pattern. Nevertheless, under some circumstances successful microscratch attacks can be conducted by identifying patterns in winning indicia and therefore adequate microscratch countermeasures should be employed whenever possible.

As further described below, in various embodiments, the present disclosure provides a lottery ticket including a substrate, winning indica printed on the substate, the winning indicia including a first pattern having a first quantity of first pattern fundamental geometric parameters, non-winning variable indicia printed on the substrate, the non-winning variable indicia including a second pattern having a second quantity of second fundamental geometric parameters, and a first scratch off coating covering the variable indicia. In various such embodiments, the second quantity of fundamental geometric parameters are within plus-or-minus (+) of a designated percentage such as +3.5% of the first quantity of fundamental geometric parameters. The non-winning winning variable indicia thus significantly resembles the winning indicia when viewed from the perspective of a microscratch attack. If a nefarious person uses a microscratch attack, the person would think that this ticket is a winning lottery ticket based on this similarity of the patterns, but in fact, it is a losing lottery ticket. After this occurs one or more times, the person would thus be discouraged from such microscratch attacks. It is noted that if the person would try to make the holes in the SOC larger to be able to better detect the pattern distinctions, the hole would be more visible to a potential customer of the lottery ticket.

As further described below, in various such embodiments, a quantity of non-winning pattern lines of the second quantity of fundamental geometric parameters are within plus-or-minus (+) 3.5% of a first quantity of indicia line angles of the first quantity of first pattern fundamental geometric parameters. As further described below, in various such embodiments, a non-winning pattern circle of the second quantity of fundamental geometric parameters is within plus-or-minus (+) 3.5% of a distance of a winning indicia circle of the first quantity of the first pattern fundamental geometric parameters. As further described below, in various such embodiments, the winning indica and the non-winning indicia are printed in a rotation orientation different from each other. As further described below, in various such embodiments, the winning indica and the non-winning indicia printed rotation is less than or equal to 5° left or right.

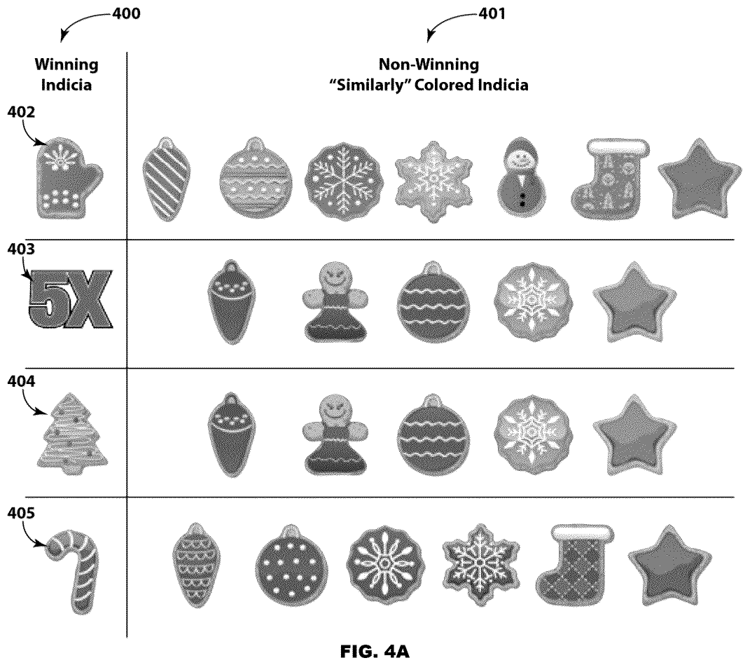

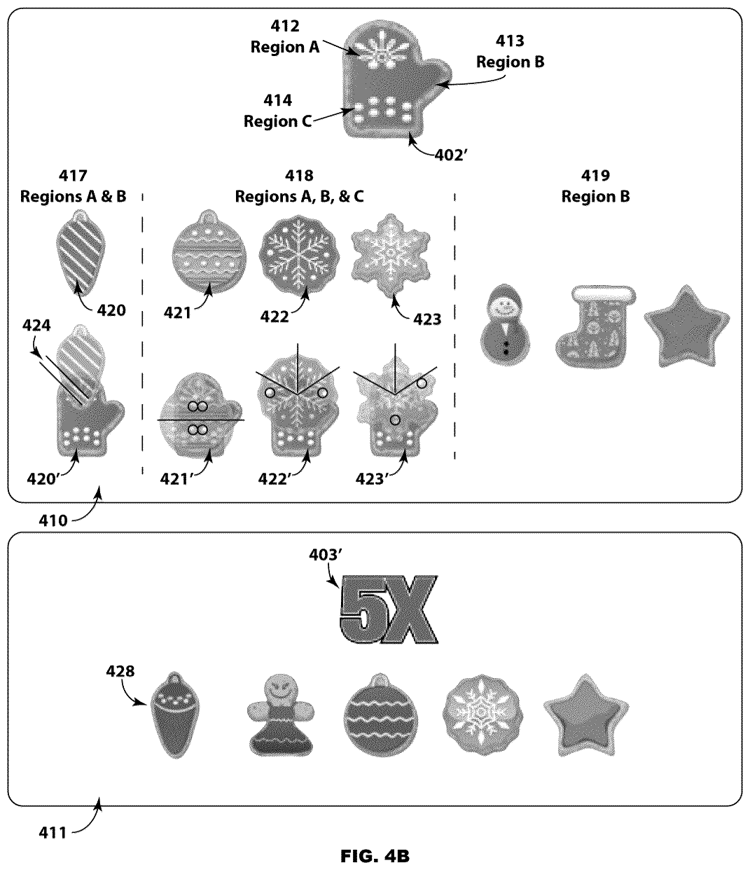

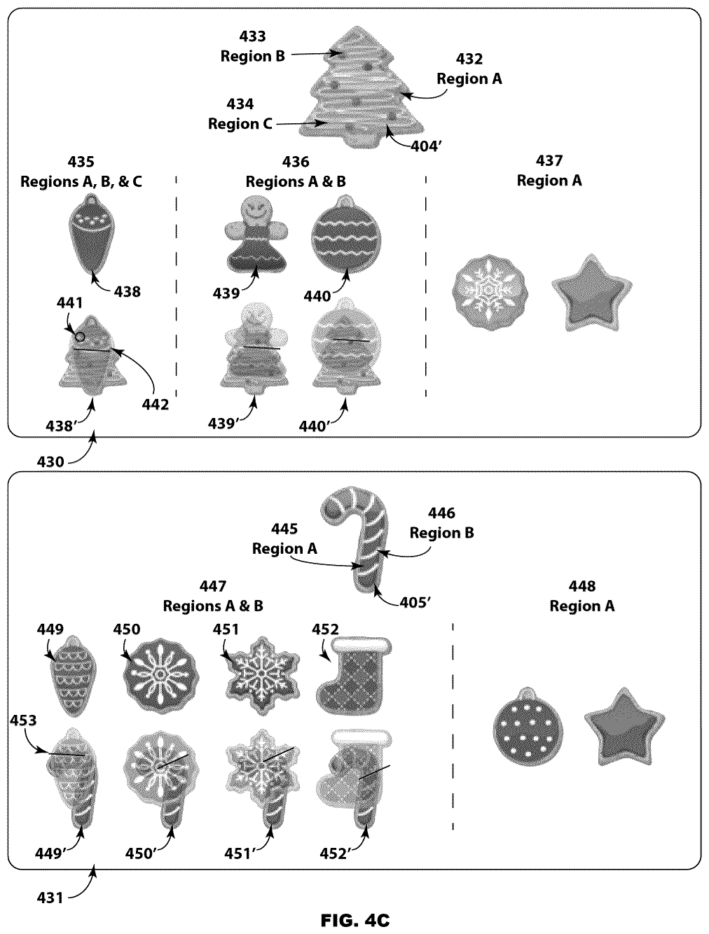

FIG. 4A illustrates the winning indicia (402 thru 405) from the previous examples (e.g., the instant ticket of FIGS. 2A, 2B, and 2C) in one column 400 of FIG. 4A with the “similarly” colored non-winning indicia 401 in the same row as the winning indicum 400. As is apparent from a cursory examination of the winning 400 and “similarly” colored non-winning indicia 401, there are various patterns in both sets of indicia. As will now be disclosed, “similar” winning 400 and non-winning 401 patterns can be utilized as a second tier countermeasure to microscratch attacks.

FIG. 4B illustrates the “mitten” 402′ and “5×” 403′ winning indicia from FIG. 4A in magnified views along with associated “similar” colored non-winning indicia arranged in two groupings including the “mitten” group 410 and “5×” group 411 as shown in FIG. 4B. The “mitten” indicum 402′ includes two different example patterns (including starburst 412 and dots 414) as well as the predominate color 413. For ease of reference, the two different patterns 412 and 414 and the predominate color 413 portions of the “mitten” indicium 402′ are each referred to as separate regions of the “mitten” indicum 402′. Specifically, “Region A” displays the starburst pattern portion 412, “Region B” displays the predominate color portion 413, and “Region C” displays the dots pattern portion 414. The “mitten” group's 410 non-winning indicia are arranged in combinations such that non-winning indicia exhibiting pattern features resembling regions on the winning “mitten” indicum are clustered together. For example, non-winning “Christmas ornament” 421 and two “snowflake” indicia 422 and 423 exhibit pattern features from all three regions of the winning “mitten” indicium 402′ and are therefore clustered into the “Regions A, B, & C” combination 418.

Starting with “Regions A & B” combination 417, its sole non-winning “Christmas tree ornament” indicium 420 features a pattern of diagonal white lines that under microscratch attacks may appear to be a portion of the starburst pattern in “Region A” 412 of the winning “mitten” indicum 402′. As shown in the supplementary translucent overlay 420′, indicium 420 diagonal white lines are approximately the same angle 424 as some of the starburst pattern lines in the winning “mitten” indicum 402′. Thus, if microscratch pin-prick holes and/or surreptitious slices are inserted through a ticket's SOC, the combination of non-winning indicum 420 diagonal white lines pattern 424 combined with the “similar” predominate color of “Region B” 413, as well as the “similar” white lines of “Region A”, can offer sufficient obfuscation to act as a combined color and pattern microscratch countermeasure. “Regions A, B, & C” combinations 418 include three non-winning indicia 421, 422, and 423 each with pattern features from all three winning “mitten” indicum regions (i.e., the starburst pattern 412, the predominate color 413, and the dots pattern 414) as shown in supplementary translucent overlays 421′, 422′, and 423′, again offering sufficient obfuscation to function as microscratch countermeasures. The three non-winning indicia clustered in “Region B” 419 simply exhibit colors “similar” to the predominate color of the winning “mitten” indicum 402′ and therefore only offer microscratch “similar” color countermeasures with no pattern countermeasures.

Group 411 is based on “5×” winning indicum 403′. However, “5×” winning indicum 403′ is comprised of a monochromatic predominate color with no distinctive patterns, and consequently “similar” colored indicia 428 are displayed in only one cluster as color countermeasures with no pattern countermeasures.

FIG. 4C illustrates the “Christmas tree” 404′ and “candy cane” 405′ winning indicia in magnified views along with associated “similar” colored non-winning indicia arranged in two groupings including the “Christmas tree” group 430 and the “candy cane” group 431. The “Christmas tree” indicum 404′ includes two different patterns (colored ornaments 433 and texture lines 434) as well as the predominate color 432. For ease of reference, the two different patterns 433 and 434 and the predominate color 432 portions of the “Christmas tree” indicium 404′ are each referred to as separate regions and specifically “Region A” 432 that displays the predominate color portion, “Region B” 433 that displays the colored ornaments pattern portion, and “Region C” 434 that displays the texture lines pattern portion. The “Regions A, B, & C” combination 435 sole non-winning Christmas tree ornament indicium 438 features patterns of a slight curved line as well as colored dots that under microscratch attacks may appear to be the texture line pattern of “Region C” 434 and/or the colored ornaments of “Region B” 433 of the winning “Christmas tree” indicum 404′. As shown in the supplementary translucent overlay 438′, the curved line pattern 422 and the colored dots pattern 441 of non-winning indicum 438 could readily be confused as the patterned portions of the winning “Christmas tree” indicum 404′. Thus, if microscratch pin-prick holes and/or surreptitious slices penetrate through a ticket's SOC, the combination of “similar” colored non-winning indicum patterns combined with the “similar” predominate color of “Region A” 432 can offer sufficient obfuscation to act as a combined color and pattern microscratch countermeasure. “Regions A & B” combinations 436 include two non-winning indicia (239 and 440) each with a “similar” predominate color and “similar” pattern to the winning “Christmas tree” indicum 404 as shown in supplementary translucent overlays 439′ and 440′, again offering sufficient obfuscation to function as combined color and pattern microscratch countermeasures. The two non-winning indicia clustered in “Region A” 437 only exhibit colors “similar” to the predominate color of the winning “Christmas tree” indicum 404′ and therefore only offer microscratch “similar” color countermeasures with no pattern countermeasures.

The “candy cane” indicum 405′ of group 431 has just one pattern including stripes 446 and a predominate color 445. As before, the pattern 446 and the predominate color 445 portions of the “candy cane” indicium 405′ are each referred to as separate regions and specifically “Region A” 445 that covers the predominate color portion, and “Region B” 446 that covers the striped pattern portion. The “Regions A & B” combination 447 includes four non-winning indicia 449 thru 452 featuring patterns of similarly colored lines that under microscratch attacks may appear to be the stripe pattern of “Region B” 446 of the winning “candy cane” indicum 405′. As shown in the supplementary translucent overlays 449′ thru 452′, the line patterns 453 (in four places) of the non-winning indicia 449 thru 452 could readily be confused as the striped pattern portion of the winning “candy cane” indicum 405′. Thus, if microscratch pin-prick holes and/or surreptitious slices are made penetrating a lottery ticket's SOC, the combination of “similarly” colored non-winning indica patterns combined with the “similar” predominate color of “Region A” 445 would offer sufficient obfuscation to act as a combined color and pattern microscratch countermeasure. The two non-winning indicia clustered in “Region A” 448 only exhibit colors “similar” to the predominate color of the winning “candy cane” indicum 405′ and therefore only offer microscratch “similar” color countermeasures with no pattern countermeasures.

Thus, by placing patterns in non-winning indicia that are “similar” to patterns appearing in winning indicia a second tier of pattern microscratch countermeasures can be achieved. In various embodiments, to ensure maximum effectiveness, the non-winning “similar” patterns are of a “similar” color to the patterns in the winning indicia and the non-winning pattern fundamental geometric parameters are within 7% of the winning patterns. In other words, in various embodiments, non-winning pattern lines have within plus-or-minus three point five percent (+3.5%) of winning indicia line angles, non-winning pattern circles have within +3.5% of the radius of winning indicia circles, and non-winning abstract pattern symbols have within +3.5% of winning pattern symbols, etc.

Various other embodiments are contemplated by the present disclosure. For example, the winning and non-winning indicia can be slightly rotated (e.g., 5° left or right) or skewed on a pseudorandom basis to increase the distortion of how a given winning pattern appears through microscratch pin-prick holes or and/or surreptitious slices, thereby enhancing the obfuscation and consequently increasing the difficulty of a successful microscratch attack.

All of the various previously disclosed example embodiments have been specifically structured to provide microscratch countermeasures for instant tickets where the winning indicia are evident on unsold pristine tickets. Hence, a nefarious attacker would know exactly which winning indicia to look for when microscratching the lottery ticket in advance of the physical microscratching process-which greatly simplifies the task. In other words, the previous example embodiments provide microscratch countermeasures (from a security perspective) for the worse case instant lottery ticket configurations. As will now be shown, these same fundamental microscratch countermeasures may also be applied to inherently more secure instant ticket configurations (i.e., better, or best case scenarios from a security perspective) with less stringent countermeasure metrics.

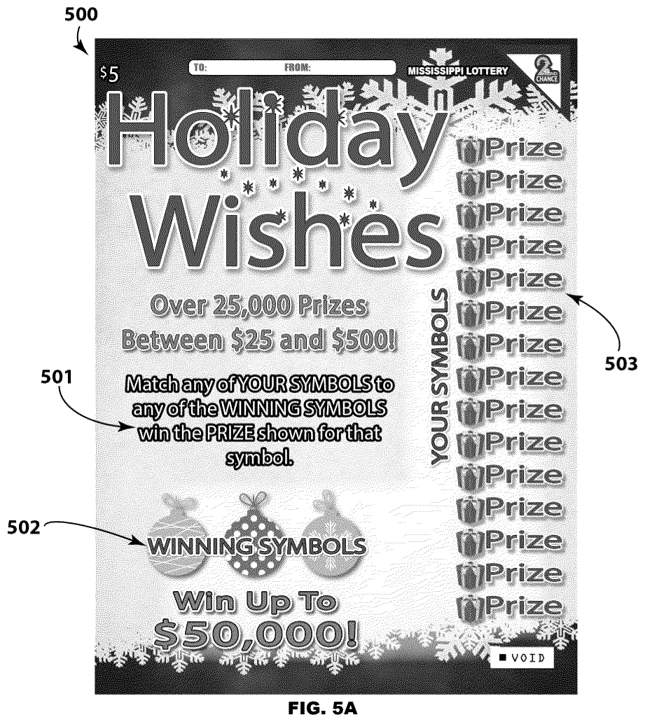

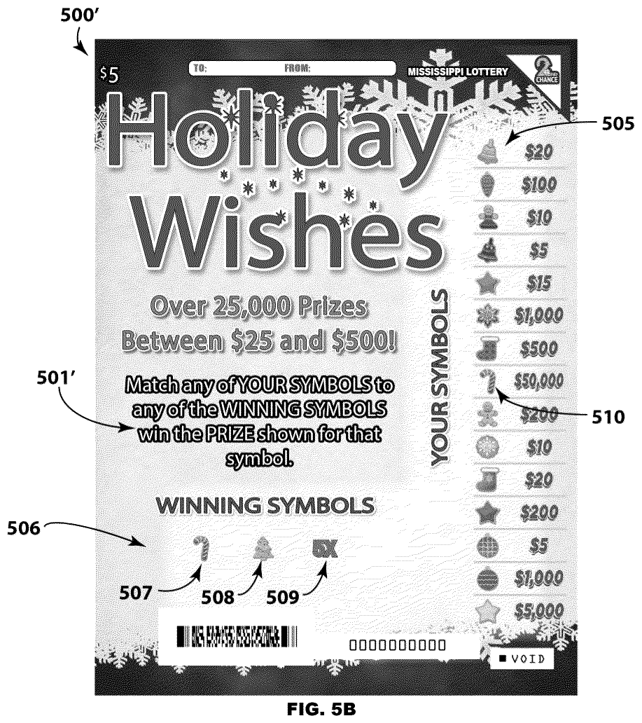

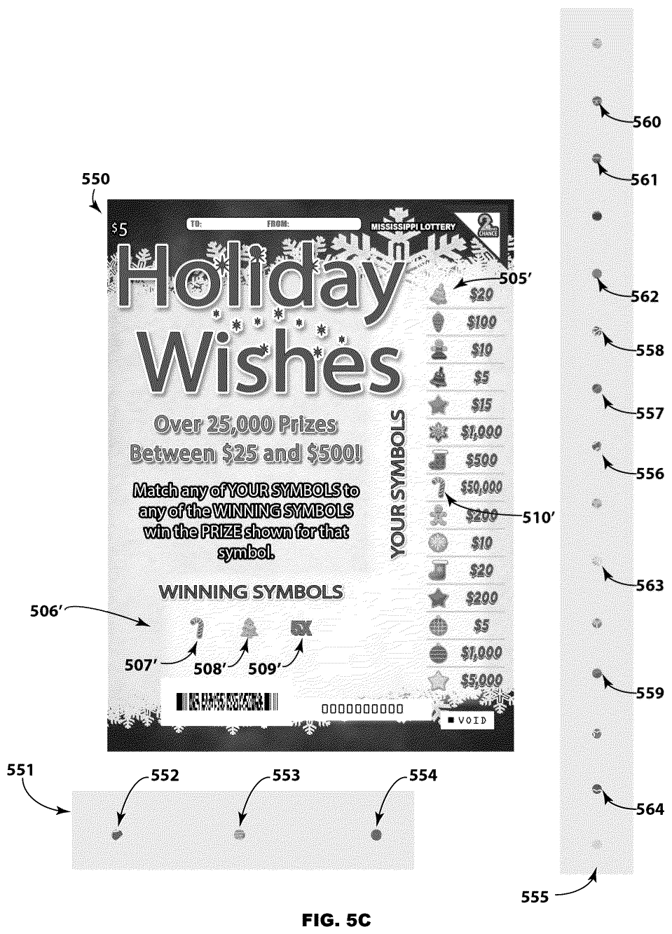

For example, FIGS. 5A, 5B, and 5C taken together, provide a detailed specific example countermeasures to microscratch attacks for full-color instant ticket “key match” games where the winning indicia are not known by observing an unsold pristine lottery ticket. FIG. 5A illustrates a front elevation view of an exemplary “key match” ticket design shown in pristine condition. FIG. 5B illustrates the same exemplary “key match” lottery ticket in fully scratched (i.e., played) condition. FIG. 5C illustrates the same exemplary front elevation view of a “key match” lottery ticket with detailed magnified views of portions of interest including microscratched pin-prick holes through areas of the SOC on a winning ticket in accordance with certain embodiments of the present disclosure.

As shown in FIGS. 5A and 5B, the modified exemplary “Holiday Wishes” instant lottery ticket 500 and 500′, respectively includes instructions 501 and 501′, respectively where the “key match” winning indicia are not disclosed on an unsold pristine lottery ticket 500 (FIG. 5A). With this modified exemplary ticket there are two SOC areas 502 and 503 including a first one covering a vertical column of “Your Symbols” indicia 505 (FIG. 5B) and a second one covering a horizontal “Winning Symbols” area 502 (FIG. 5A). With this modified exemplary “Holiday Wishes” instant lottery ticket, the game instructions 501 (clearly visible on pristine lottery tickets) simply instruct the consumer to “Match any of YOUR SYMBOLS to any of the WINNING SYMBOLS win the PRIZE show for that symbol.” In other words, all of the variable indicia hidden under the “WINNING SYMBOLS” SOC 502 are the winning indicia for this game, but are not known to the customer until SOC 502 is removed. In such embodiments, the hidden winning indicia change from ticket-to-ticket. This seemingly minor change in the ticket's play style greatly increases the security of the instant lottery ticket with respect to microscratch attacks because the nefarious attacker must attempt to identify both the winning indicia 507 thru 509 of FIG. 5B and any winning indicia from a plurality of indicia 505 that may be printed under the “YOUR SYMBOLS” SOC 503 (FIG. 5A)—e.g., winning indicum 510 of FIG. 5B.

The same lottery ticket 501′ of FIG. 5B is illustrated 550 in FIG. 5C with additional magnified views 551 and 555 of microscratch pin-prick holes through the SOCs concealing the “YOUR SYMBOLS” 505′ (fifteen indicia) and “WINNING SYMBOLS” 506′ (three indicia) portions. The FIG. 5C revealed “WINNING SYMBOLS” 506′ area shows the “key match” winning indicia 507′ thru 509′ with the associated matching $50,000 winning indicum 510′ in the revealed “YOUR SYMBOLS” area 505′. For brevity, the same winning symbols that were identified in the previous exemplary instant ticket of FIGS. 2A thru 2F were also selected as the “WINNING SYMBOLS” 507′ thru 509′ in the example of FIGS. 5B and 5C. This similarity is not to infer that these same winning symbols would appear under the SOC 502 (FIG. 5A) on every lottery ticket in the modified exemplary game of FIGS. 5A thru 5C, again the reason that identical winning symbols from the previous example were selected is for ease of explanation.

Returning to FIG. 5C, the ticket's 550 winning “candy cane” indicum 507′ and 510′ predominate red color appears in its associated microscratch pin-prick holes 552 and 556 as before, however with this exemplary game format, the nefarious microscratch attacker only knows by inspecting the microscratch holes 552 thru 554 that one of the winning indicia is predominately red and that the other two winning indicia are predominately green shades. For example, the winning “candy cane” indicum 510′ appearing through microscratch holes 552 (“WINNING SYMBOLS” area 551) and 556 (“YOUR SYMBOLS” area 555) could easily be mistaken for any of the other predominately red colored non-winning “YOUR SYMBOLS” 557 thru 560. The other two “WINNING SYMBOLS” 508′ and 509′ predominate green color shades observed through microscratch holes 553 and 554 again could also be easily confused for the predominately green colored non-winning “YOUR SYMBOLS” 561 thru 564.

With only a single microscratch hole per indicium, the nefarious microscratch attacker has no idea if there are any other colors, color fades, and/or patterns associated with any winning indicia. Accordingly, the task of the nefarious microscratch attacker has become much more difficult so long as “similar colored” non-winning indicia (e.g., 557 thru 560) are also placed in the “YOUR SYMBOLS” area 505′. The nefarious microscratch attacker has the option to add more pin-prick holes per indicum; however the added holes have the disadvantages of increasing the chance that a consumer will detect the microscratch attack. The act of increasing a number of stealthily added microscratch holes and/or surreptitious slices also substantially increases the time required to perform the task such that most financial incentives for the nefarious microscratch attacker are expected to be eliminated.

As before, the modified exemplary game of FIGS. 5A thru 5C can be made secure against microscratching attacks by ensuring that there is at least one non-winning indicium (e.g., 557 and 562) colored similarly to each corresponding winning indicum on every ticket. However, in the context of the modified format of FIGS. 5A thru 5C, the metrics for “similarly colored” non-winning indicia can be expanded to include a greater set of colors as well as greater variability for patterns.

For example, with the previously disclosed dominate color embodiment, the radius of the circle on the color gamut and consequently the area may be increased from the radius being equal to the previously stated “delta divided by two (Δ/2)” value (suggested for instant tickets where the identity of the winning indicia are known to a nefarious microscratch attacker) to an increased radius with instant tickets where the identities of the winning indicia are unknown on a pristine ticket such that a larger area on the color gamut is covered for “similar” colors—e.g., the delta value itself becomes the radius, 75% of the delta value becomes the radius, 80% of the delta value becomes the radius. With the previously disclosed standard deviation embodiment, the radius of the circle on the color gamut and associated area may be increased from the two sigma (20) value to a three sigma (30) value for instant tickets where the identities of the winning indicia are unknown to a nefarious microscratch attacker. With the previously disclosed theoretical static radius (r) embodiment, the radius of the circle on the color gamut may be increased from 13% to 17% or more for instant tickets where the identities of the winning indicia are unknown to a nefarious microscratch attacker. Likewise, the pattern obfuscation embodiments previously disclosed can also be expanded to wider parameters—e.g., non-winning pattern fundamental geometric parameters could be within 20% of the winning patterns.

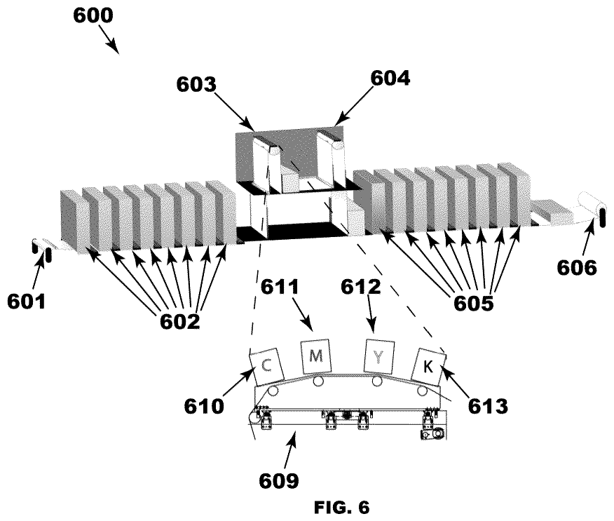

One example press configuration 600 capable of producing the instant tickets process color variable indicia embodiments of FIGS. 2A thru 2F and 5A thru 5C is illustrated in FIG. 6. As shown in FIG. 6, press configuration 600 illustrates a hybrid flexographic and digital imager printing press used to produce variable indicia SOC secured instant tickets. The printing press 600 unravels its paper web substrate from a roll 601 and flexographically prints 602 lower security coatings and a primer in the scratch-off area as well as optionally prints display (i.e., the region on the front of the SOC document not covered by SOC) and the back of the document's non-variable information. At this point, the press web enters a secured imager room where the variable indicia are applied by an imager 603. However, in view of this disclosure, the imager employed would be a process color imager 609 (e.g., Memjet® Duralink) instead of a monochromatic imager. The process color imager 609 has the advantage of full-color printing, since the imager is equipped with multiple discrete print heads each imaging a primary component color (e.g., cyan 610, magenta 611, yellow 612, and black 613 as illustrated in 600).

The remainder of press configuration 600 can remain in accordance with the industry standard for producing SOC protected documents with a second, monochromatic, imager 604 utilized to print the variable information presented on the back of the SOC protected document (e.g., inventory barcode). Subsequently, a series of flexographic print stations 605 print the upper security layers of a SOC document (e.g., a clear release coat, an upper blocking black coat, a white coating) as well as the decorative overprint (i.e., the process color or spot colors applied as an image or pattern on top of the scratch-off portion) with the web typically being rewound into a roll 606 for storage and ultimate processing by a separate packaging line.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

What is claimed is:

1. A method of manufacturing a plurality of physical lottery tickets for a same instant lottery ticket game, said method comprising:
determining a range of different colors that can be printed by a CMYK (Cyan, Magenta, Yellow, and black) printer, wherein each of the different colors comprises a different combination of amounts of Cyan ink, Magenta ink, Yellow ink, and black ink;
determining a subset of the range of different colors;
selecting a first color of the subset of the range of different colors, wherein the first color comprises a first combination of amounts of Cyan ink, Magenta ink, Yellow ink, and black ink;
selecting a second color of the subset of the range of different colors, wherein the second color is different than the first color, wherein the second color comprises a different second combination of amounts of Cyan ink, Magenta ink, Yellow ink, and black ink;
selecting a third color of the subset of the range of different colors, wherein the third color is different than the first color and different than the second color, wherein the third color comprises a different third combination of amounts of Cyan ink, Magenta ink, Yellow ink, and black ink;
selecting a winning variable indicium for a winning first lottery ticket of the plurality of lottery tickets;
selecting a first non-winning variable indicium for a losing second lottery ticket of the plurality of lottery tickets;
selecting a second non-winning variable indicium for a losing third lottery ticket of the plurality of lottery tickets;
using the CMYK printer, printing the winning variable indicium in the first color on a first substrate of the winning first lottery ticket;
forming a first scratch off coating covering the winning variable indicium;
using the CMYK printer, printing the first non-winning variable indicium in the second color on a second substrate of the losing second lottery ticket;
forming a second scratch off coating covering the first non-winning variable indicium;
using the CMYK printer, printing the second non-winning variable indicium in the third color on a third substrate of the losing third lottery ticket; and
forming a third scratch off coating covering the second non-winning variable indicium.

2. The method of claim 1, wherein the second color varies from the first color in shade.

3. The method of claim 2, wherein the third color varies from the first color in shade.

4. The method of claim 3, wherein the third color varies from the second color in shade.

5. The method of claim 1, wherein the second color varies from the first color in hue.

6. The method of claim 2, wherein the third color varies from the first color in hue.

7. The method of claim 6, wherein the third color varies from the second color in hue.

8. The method of claim 1, wherein the second color varies from the first color in shade and hue.

9. The method of claim 8, wherein the third color varies from the first color in shade and hue.

10. The method of claim 9, wherein the third color varies from the second color in shade and hue.

11. The method of claim 1, wherein the first combination of amounts of Cyan ink, Magenta ink, Yellow ink, and black ink for the first color comprises:
a first amount of a first ink, wherein the first ink is one of Cyan ink, Magenta ink, Yellow ink, and black ink, wherein the first amount of the first ink comprises at least fifty percent of ink used to form the first color, and
a second amount of a second ink that is different than the first ink, wherein the second ink is another one of Cyan ink, Magenta ink, Yellow ink, and black ink, wherein the second amount of the second ink comprises less than fifty percent of ink used to form the first color.

12. The method of claim 11, wherein the second combination of amounts of Cyan ink, Magenta ink, Yellow ink, and black ink for the second color comprises:
a third amount of the first ink, wherein the third amount of the first ink comprises at least fifty percent of ink used to form the second color, and
a fourth amount of a third ink that is different than the first ink and different than the second ink, wherein the third ink is one of Cyan ink, Magenta ink, Yellow ink, and black ink, wherein the fourth amount of the third ink comprises less than fifty percent of ink used to form the second color.

13. The method of claim 12, wherein the third combination of amounts of Cyan ink, Magenta ink, Yellow ink, and black ink for the third color comprises:
a fifth amount of the first ink, wherein the fifth amount of the first ink comprises at least fifty percent of ink used to form the third color, and
a sixth amount of a fourth ink that is different than the first ink and different than the second ink, wherein the fourth ink is one of Cyan ink, Magenta ink, Yellow ink, and black ink, wherein the sixth amount of the fourth ink comprises less than fifty percent of ink used to form the third color.

14. The method of claim 13, wherein each of the first color, the second color, and the third color each comprises at least three of Cyan ink, Magenta ink, Yellow ink, and black ink.

15. The method of claim 13, wherein each of the first color, the second color, and the third color each comprises each of Cyan ink, Magenta ink, Yellow ink, and black ink.

16. The method of claim 1, wherein the first combination of amounts of Cyan ink, Magenta ink, Yellow ink, and black ink for the first color comprises at least three of Cyan ink, Magenta ink, Yellow ink, and black ink.

17. The method of claim 16, wherein the second combination of amounts of Cyan ink, Magenta ink, Yellow ink, and black ink for the second color comprises at least three of Cyan ink, Magenta ink, Yellow ink, and black ink.

18. The method of claim 17, wherein the second combination of amounts of Cyan ink, Magenta ink, Yellow ink, and black ink for the second color comprises at least three of Cyan ink, Magenta ink, Yellow ink, and black ink.

19. The method of claim 1, wherein the first combination of amounts of Cyan ink, Magenta ink, Yellow ink, and black ink for the first color comprises each of Cyan ink, Magenta ink, Yellow ink, and black ink.

20. The method of claim 19, wherein the second combination of amounts of Cyan ink, Magenta ink, Yellow ink, and black ink for the second color comprises each of Cyan ink, Magenta ink, Yellow ink, and black ink.
